(19) United States
(12) Patent Application Publication
(10) Pub. No.: US 2023/0018132 A1
(43) Pub. Date: Jan. 19, 2023

(54) REVERSIBLY THERMOCHROMIC AQUEOUS INKJET PRINTER INK COMPOSITION, INKJET PRINTER AND INK CARTRIDGE USING THE SAME

(71) Applicants: KABUSHIKI KAISHA PILOT CORPORATION (also trading as PILOT CORPORATION), Tokyo-to (JP); THE PILOT INK CO., LTD., Nagoya-shi (JP); TOSHIBA TEC KABUSHIKI KAISHA, Tokyo (JP)

(72) Inventors: Masayuki MITA, Nagoya-shi (JP); Ryo YAMADA, Tokyo-to (JP)

(21) Appl. No.: 17/851,563

(22) Filed: Jun. 28, 2022

(30) Foreign Application Priority Data
Jun. 30, 2021 (JP) 2021-109525

(51) Int. Cl. C09D 11/50; C09D 11/38; C09D 11/322; C09D 11/033; B41J 2/175

(52) U.S. Cl. CPC C09D 11/50; C09D 11/38; C09D 11/322; C09D 11/033; B41J 2/17503

(57) ABSTRACT

The present invention provides a reversibly thermochromic aqueous inkjet printer ink composition which can form print images of high resolution and rich color development. The composition comprises: a reversibly thermochromic microcapsule pigment, water, and a polyalcohol organic solvent. Microcapsules which are comprised in the composition have a volume-based mean particle size (X) of 0.1 to 2 μm and a mean cross-sectional membrane thickness (Y) of 0.02 to 0.4 which is average of cross-sectional membrane thickness defined by the formula:

cross-sectional membrane thickness=(outer section diameter−inner section diameter)/2.

### CROSS REFERENCE TO RELATED APPLICATIONS

This application is based upon and claims the benefit of priority from the prior Japanese Patent Application No. 2021-109525, filed on Jun. 30, 2021, the entire contents of which are incorporated herein by reference.

### FIELD

The present invention relates to a reversibly thermochromic aqueous inkjet printer ink composition. Further, the invention also relates to an inkjet printer and an ink cartridge using the same.

### BACKGROUND

Hitherto, there have been proposed some inkjet printer ink compositions to which thermochromic microcapsule pigments enclosing transition element compounds and/or thermochromic compositions are applied (e.g., see, Patent documents 1 to 3). However, it has been difficult not only to obtain a print image of high resolution and of rich color development but also to realize long-term stable image formation without troubles such as clogging of nozzles.

For example, when an ink composition containing small-size microcapsules is adopted, it can be realized to inhibit the microcapsules from clogging the printer nozzles and thereby to keep good inkjet performance. On the other hand, however, as for color development, the microcapsule pigment and the print image are liable to deteriorate. In contrast, when an ink composition containing large-size microcapsules is adopted, the microcapsule pigment is improved in color development but the nozzles are often clogged with the microcapsule pigment to lower the print image resolution and to adversely affect the inkjet performance.

For the purpose of preventing nozzle clogging caused by dried ink, it has been also studied to incorporate moisturizers into ink compositions. However, while some ink compositions containing moisturizers are stored, color fading of the microcapsule pigments is often caused by thermochromic ingredients oozing from the microcapsules into ink solvents. Although this color fading of the microcapsule pigments can be avoided by thickening the microcapsule membranes, other troubles may be induced if the membranes are simply thickened. Specifically, if the membranes are thickened without changing the capsule size, the amount of the thermochromic ingredients enclosed in the microcapsules are decreased to lower color development of the microcapsule pigments. In contrast, however, if the membranes are thickened without changing the amount of the enclosed thermochromic ingredients, the capsule size is increased to lower the print image resolution and to adversely affect the inkjet performance. For those reasons, it has been difficult to ensure good preservation stability, sufficient color development and high resolution of print images, and stable inkjet performance at the same time.

### PRIOR ART DOCUMENTS

### Patent Documents

[Patent document 1] JP2009-227956A
[Patent document 2] WO2018/190229A
[Patent document 3] WO2018/190230A

### SUMMARY OF INVENTION

To cope with the above problem, the present invention provides a reversibly thermochromic aqueous inkjet printer ink composition having good preservation stability, realizing sufficient color development and high resolution of print images and ensuring stable inkjet performance.

### Means for Solving Problem

The reversibly thermochromic aqueous inkjet printer ink composition according to the present Invention comprises: a reversibly thermochromic microcapsule pigment containing microcapsules in which

a reversibly thermochromic composition containing:
(A) an electron-donative coloring organic compound,
(B) an electron-accepting compound, and
(C) a reaction medium for reversibly causing an electron transfer reaction between the components (A) and (B) in a specific temperature range

is enclosed with a membrane,

water, and
a polyalcohol organic solvent;
wherein

said microcapsules have a volume-based mean particle size (X) of 0.1 to 2 μm and a mean cross-sectional membrane thickness (Y) of 0.02 to 0.4 μm, provided that said mean cross-sectional membrane thickness is defined by the steps of

observing cross-sections of said microcapsules in the frozen state with a transmission electron microscope,

calculating cross-sectional membrane thicknesses of all the microcapsules in the observation field according to the following formula:

cross-sectional membrane thickness=(outer section diameter−inner section diameter)/2

(in which the outer and inner section diameters of each microcapsule are circle conversion diameters calculated from areas surrounded by the outer and inner circumferences, respectively), and

averaging the calculated thicknesses to determine the mean cross-sectional membrane thickness.

Further, the inkjet printer according to the present invention is characterized by being loaded with the above ink composition.

Furthermore, the ink cartridge according to the present invention is characterized by being charged with the above ink composition.

The present invention provides a reversibly thermochromic aqueous inkjet printer ink composition capable of forming print images of high resolution and rich color development. This Ink composition is excellent in temporal stability and can keep stable inkjet performance for a long time. The invention also provides an inkjet printer and an ink cartridge which have those characteristics.

### BRIEF DESCRIPTION OF THE DRAWINGS

FIG. 1 is a graph illustrating hysteresis characteristics in the color density-temperature curve of a heat-decoloring type reversibly thermochromic composition.

FIG. 2 is a graph illustrating hysteresis characteristics in the color density-temperature curve of a heat-decoloring type reversibly thermochromic color-memory composition.

FIG. 3 is a graph illustrating hysteresis characteristics in the color density-temperature curve of a heat color-developing type reversibly thermochromic composition.

FIG. 4 is a schematic sectional view showing an example of constitution of an inkjet printer.

### DETAILED DESCRIPTION

The reversibly thermochromic aqueous inkjet printer ink composition (hereinafter, often referred to as “ink composition”) of the present invention comprises, at least, a reversibly thermochromic microcapsule pigment, water, and a polyalcohol organic solvent. With respect to each of those ingredients constituting the ink composition of the invention, the explanation is given below.

The ink composition of the invention contains a reversibly thermochromic microcapsule pigment (hereinafter, often referred to as “microcapsule pigment”) as a colorant.

The microcapsule pigment used in the ink composition of the invention contains microcapsules in which a reversibly thermochromic composition is enclosed, and hence the pigment is typically aggregate of microcapsules. As the reversibly thermochromic composition, it is possible to adopt a heat-decoloring type one (which decolorizes when heated but colors when cooled) necessarily containing indispensable three components, that is, (A) an electron-donative coloring organic compound, (B) an electron-accepting compound, and (C) a reaction medium determining the temperature causing a coloring reaction between the components (A) and (B).

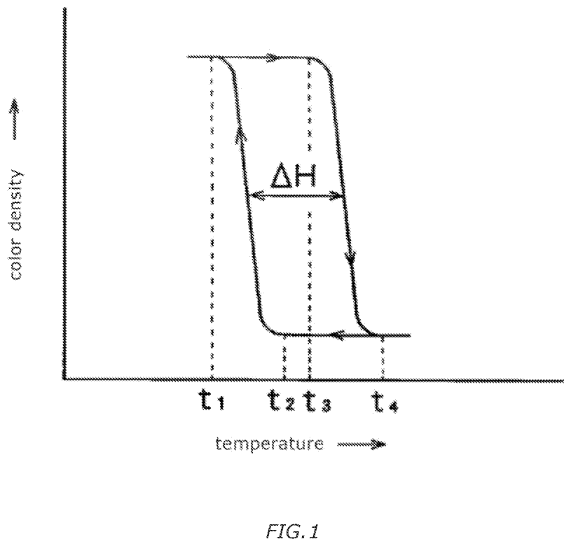

JP1976-044706B, JP1976-044707B and JP1989-029398B disclose an example of the reversibly thermochromic composition appliable to the above microcapsule pigment. That composition changes its color at a specific temperature (color-changing point). Specifically, it shows colorless in the temperature range higher than the color-changing point, but colorizes at a temperature lower than the point. The composition at a temperature in the room temperature range selectively keeps only one of those two color states, and the other color state appears only while the composition is heated or cooled. When heating or cooling is stopped, the color state returns to that at room temperature. As for the hysteresis width (ΔH) of those hysteresis characteristics, the composition disclosed as an example has a relatively small hysteresis width (ΔH=1 to 7° C.) (see, FIG. 1).

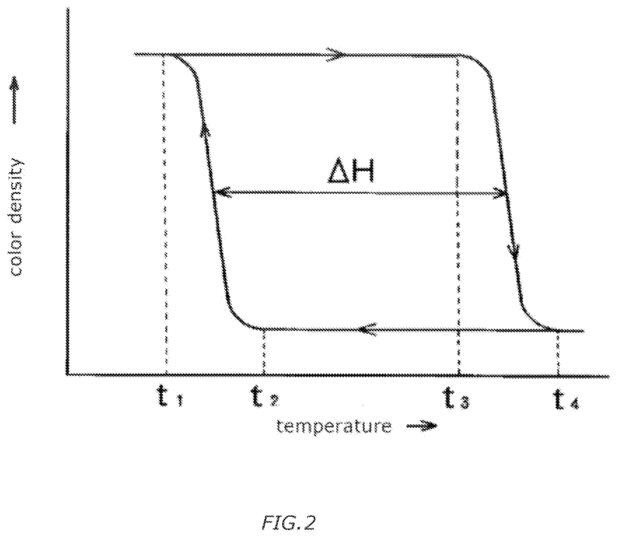

Anther example of the reversibly thermochromic composition appliable to the above microcapsule pigment is disclosed, for example, in JP1992-017154B, JP1995-179777A, JP1995-033997A, JP1996-039936A and JP2005-001369A. The disclosed composition shows hysteresis characteristics having a large hysteresis width (ΔH=8 to 70° C.). Specifically, the curve obtained by plotting the changes of color density according to the temperature follows very different paths between when the temperature is increased from the region lower than the color-changing region and when the temperature is decreased from the region higher than the color-changing region. Consequently, the colored state at a temperature not higher than the complete coloring temperature t₁ and the decolored state at a temperature not lower than the complete decoloring temperature t₄ are continued to retain color-memory in a specific temperature region (temperature range between the coloring starting temperature t₂ and the decoloring starting temperature t₃[essentially two-phase retaining temperature range]) (see, FIG. 2).

### [Microcapsule Pigment]

Each of the components (A), (B) and (C) will be specifically explained below.

The component (A), which is an electron-donative coloring organic compound serving as an ingredient determining the color, develops the color by donating an electron to the component (B) serving as a color developer.

Examples of the electron-donative coloring organic compound include: phthalide compounds, fluoran compounds, styrynoquinoline compounds, diazarhodamine lactone compounds, pyridine compounds, quinazoline compounds, and bisquinazoline compounds. Among them, phthalide compounds and fluoran compounds are preferred.

Examples of the phthalide compounds include: diphenylmethane phthalide compounds, phenylindolyl phthalide compounds, indolyl phthalide compounds, diphenylmethane azaphthalide compounds, phenylindolyl azaphthalide compounds and derivatives thereof. Among them, phenylindolyl azaphthalide compounds and their derivatives are preferred.

Further, examples of the fluoran compounds include: aminofluoran compounds, alkoxyfluoran compounds and derivatives thereof.

Examples of the compounds employable as the component (A) are as follows:
3,3-bis(4-dimethylaminophenyl)-6-dimethylaminophthalide,
3-(4-diethylaminophenyl)-3-(1-ethyl-2-methylindol-3-yl)phthalide,
3,3-bis(1-n-butyl-2-methylindol-3-yl)phthalide,
3,3-bis(2-ethoxy-4-diethylaminophenyl)-4-azaphthalide,
3-(2-ethoxy-4-diethylaminophenyl)-3-(1-ethyl-2-methylindol-3-yl)-4-azaphthalide,
3-(2-n-hexyloxy-4-diethylaminophenyl)-3-(1-ethyl-2-methylindol-3-yl)-4-azaphthalide,
3-[2-ethoxy-4-(N-ethylanilino)phenyl]-3-(1-ethyl-2-methylindol-3-yl)-4-azaphthalide,
3-(2-acetamido-4-diethylaminophenyl)-3-(1-propyl-2-methylindol-3-yl)-4-azaphthalide,
3,6-bis(diphenylamino)fluoran,
3,6-bis(N-phenyl-N-tolylamino)fluoran,
3,6-dimethoxyfluoran,
3,6-di-n-butoxyfluoran,
2-methyl-6-(N-ethyl-N-p-tolylamino)fluoran,
3-chloro-6-cyclohexylaminofluoran,
2-methyl-6-cyclohexylaminofluoran,
2-chloroamino-6-di-n-butylaminofluoran,
2-(2-chloroanilino)-6-di-n-butylaminofluoran,
2-(3-trifluoromethylanilino)-6-diethylaminofluoran,
2-(3-trifluoromethylanilino)-6-di-n-pentylaminofluoran,
2-dibenzylamino-6-diethylaminofluoran,
2-(N-methylanilino)-6-(N-ethyl-N-p-tolylamino)fluoran,
1,3-dimethyl-6-diethylaminofluoran,
2-chloro-3-methyl-6-diethylaminofluoran,
2-anilino-3-methyl-6-diethylaminofluoran,
2-anilino-3-methoxy-6-diethylaminofluoran,
2-anilino-3-methyl-6-dl-n-butylaminofluoran,
2-anilino-3-methoxy-6-di-n-butylaminofluoran,
2-xylidino-3-methyl-6-diethylaminofluoran,
2-anilino-3-methyl-6-(N-ethyl-N-p-tolylamino)fluoran,
6-diethylamino-1,2-benzofluoran,
6-(N-ethyl-N-isobutylamino)-1,2-benzofluoran
6-(N-ethyl-N-isopentylamino)-1,2-benzofluoran,
2-(3-methoxy-4-dodecoxystyryl)quinoline,
2-diethylamino-8-diethylamino-4-methyl,
spiro[5H-[1]benzopyrano[2,3-d]pyrimidine-5,1′(3′H)isobenzofuran]-3′-one,
2-di-n-butylamino-8-di-n-butylamino-4-methyl,
2-di-n-butylamino-8-diethylamino-4-methyl,
2-di-n-butylamino-8-(N-ethyl-N-isoamylamino)-4-methyl,
2-di-n-butylamino-8-di-n-pentylamino-4-methyl,
4,5,6,7-tetrachloro-3-(4-dimethylamino-2-methoxyphenyl)-3-(1-n-butyl-2-methylindol-3-yl)-1(3H)-isobenzofuranone,
4,5,6,7-tetrachloro-3-(4-diethylamino-2-ethoxyphenyl)-3-(1-ethyl-2-methylindol-3-yl)-1(3H)-isobenzofuranone,
4,5,6,7-tetrachloro-3-(4-diethylamino-2-ethoxyphenyl)-3-(1-n-pentyl-2-methylindol-3-yl)-1(3H)-isobenzofuranone,
4,5,6,7-tetrachloro-3-(4-diethylamino-2-methylphenyl)-3-(1-ethyl-2-methylindol-3-yl)-1(3H)-isobenzofuranone,
3′,6′-bis[phenyl(2-methylphenyl)amino]spiro[isobenzofuran-1(3H),9′-[9H]xanthen]-3-one,
3′,6′-bis[phenyl(3-methylphenyl)amino]spiro[isobenzofuran-1(3H),9′-[9H]xanthene]-3-one,
3′,6′-bis[phenyl(3-ethylphenyl)amino]spiro[isobenzofuran-1(3H),9′-[9H]xanthene]-3-one,
2,6-bis(2′-ethyloxyphenyl)-4-(4′-dimethylaminophenyl)pyridine,
2,6-bis(2′,4′-diethyloxyphenyl)-4-(4′-dimethylaminophenyl)pyridine,
2-(4′-dimethylaminophenyl)-4-methoxyquinazoline, and
4,4′-ethylenedioxy-bis[2-(4-diethylaminophenyl)quinazoline].

The fluorans may be not only compounds which have substituents in phenyl groups forming their xanthene rings, but also compounds which have substituents (e.g., an alkyl group such as a methyl group or a halogen atom such as a chloro group) in phenyl groups forming their lactone ring rings as well as in phenyl groups forming their xanthene rings and which are colored in black or blue

The component (B) is an electron-accepting compound functioning as a color developer of the component (A) by receiving an electron from the component (A).

Examples of the electron-accepting compound include: active proton-containing compounds; pseudo-acidic compounds (which are not acids but play the role of acids in the reversibly thermochromic composition to make the component (A) develop a color); and compounds having electron holes. Among them, the component (b) is preferably a compound selected from the group of active proton-containing compounds.

Examples of the active proton-containing compounds include: compounds having phenolic hydroxy groups and derivatives thereof, carboxylic acids and derivatives thereof, acidic phosphoric esters and derivatives thereof, azole-based compounds and derivatives thereof, 1,2,3-triazole and derivatives thereof, cyclic carbosulfoimides, halohydrins having 2 to 5 carbon atoms, sulfonic acids and derivatives thereof, and inorganic acids. The carboxylic acids and derivatives thereof are preferably aromatic carboxylic acids and derivatives thereof and also preferred are aliphatic carboxylic acids having 2 to 5 carbon atoms and derivatives thereof.

Examples of the pseudo-acidic compounds include: metal salts of the phenolic hydroxy group-containing compounds, of the carboxylic acids, of the acidic phosphoric esters, and of the sulfonic acids; aromatic carboxylic anhydrides, aliphatic carboxylic anhydrides, mixture anhydride of aromatic carboxylic acids and sulfonic acids, and cycloolefin dicarboxylic anhydrides; urea and derivatives thereof, and thiourea and derivatives thereof; guanidine and derivatives thereof, and halogenated alcohols.

Examples of the compounds having electron holes include: borates, borate esters, and inorganic salts.

Among the above compounds usable as the component (B), the phenolic hydroxy group-containing compound is preferred because they can effectively show the thermochromic properties.

The phenolic hydroxy group-containing compounds include a wide range of compounds, such as compounds ranging from monophenol compounds to polyphenol compounds, and further bis-type and tris-type phenols, phenol-aldehyde condensation resins and the like are also included therein. It is preferred for the phenolic hydroxy group-containing compound to contain at least two benzene rings. Further, the compound may also have a substituent, such as an alkyl group, an aryl group, an acyl group, an alkoxycarbonyl group, a carboxy group and an ester thereof, an amide group and a halogen group.

Examples of the metal contained in the metal salts of the phenolic hydroxy group-containing compounds and the like include: sodium, potassium, calcium, zinc, zirconium, aluminum, magnesium, nickel, cobalt, tin, copper, iron, vanadium, titanium, lead, and molybdenum.

Examples of the compounds employable as the component (B) are as follows:

compounds having one phenolic hydroxy group, such as,
phenol,
o-cresol,
m-cresol,
p-cresol,
4-ethylphenol,
4-n-propylphenol,
4-n-butylphenol,
2-tert-butylphenol,
3-tert-butylphenol,
4-tert-butylphenol,
4-n-pentylphenol,
4-tert-pentylphenol,
4-n-octylphenol,
4-tert-octylphenol,
4-n-nonylphenol,
4-n-dodecylphenol,
3-n-pentadecylphenol,
4-n-stearylphenol,
1-(4-hydroxyphenyl)decane-1-one,
4-chlorophenol,
4-bromophenol,
4-trifluoromethylphenol,
4-methylthiophenol,
4-nitrophenol,
2-phenylphenol,
4-phenylphenol,
2-benzylphenol,
2-benzyl-4-chlorophenol,
4-cumylphenol,
4-hydroxybenzophenone,
4-chloro-4′-hydroxybenzophenone,
4-fluoro-4′-hydroxybenzophenone,
4-cyclohexylphenol,
2-hydroxybenzyl alcohol,
3-hydroxybenzyl alcohol,
4-hydroxybenzyl alcohol,
4-(2-hydroxyethyl)phenol,
3-methoxyphenol,
4-ethoxyphenol,
4-n-propoxyphenol,
4-n-butoxyphenol,
4-n-heptyloxyphenol,
4-(2-methoxyethyl)phenol,
α-naphthol,
β-naphthol,
2,3-dimethylphenol,
2,4-dimethylphenol,
2,6-dimethylphenol,
2,6-di-tert-butylphenol,
2,4-dichlorophenol,
2,4-difluorophenol,
thymol,
3-methyl-4-methylthiophenol,
2-tert-butyl-5-methylphenol,
2,6-bis(hydroxymethyl)-4-methylphenol,
2,3,5-trimethylphenol,
2,6-bis(hydroxymethyl)-4-tert-octylphenol,
6-hydroxy-1,3-benzooxathiol-2-one,
2,4-bis(phenylsulfonyl)phenol,
2,4-bis(phenylsulfonyl)-5-methylphenol,
2,4-bis(4-methylphenylsulfonyl)phenol,
2-phenylphenol, 4-phenylphenol,
2,6-diphenylphenol,
3-benzylbiphenyl-2-ol,
3,5-dibenzylbiphenyl-4-ol,
4-cyano-4′-hydroxybiphenyl,
1-hydroxybenzotriazole,
1-hydroxy-5-methylbenzotriazole,
1-hydroxy-5-chlorobenzotriazole,
1-hydroxy-5-methoxybenzotriazole,
1-hydroxy-4-benzoylaminobenzotriazole,
1-hydroxy-4,5,6,7-tetrachlorobenzotriazole,
1,4-hydroxybenzotriazole,
1-hydroxy-5-nitrobenzotriazole,
1-hydroxy-5-phenylbenzotriazole,
1-hydroxy-5-benzylbenzotriazole,
1-hydroxy-5-ethylbenzotriazole,
1-hydroxy-5-n-octylbenzotriazole,
1-hydroxy-5-n-butylbenzotriazole,
n-butyl 4-hydroxybenzoate,
n-octyl 4-hydroxybenzoate,
4-hydroxybenzoate 2-heptadecafluorooctylethane,
benzyl 4-hydroxybenzoate,
4-hydroxybenzoic benzyl ester,
4-hydroxybenzoate-o-methylbenzyl,
4-hydroxybenzoate-m-methylbenzyl,
4-hydroxybenzoate-p-methylbenzyl,
4-hydroxybenzoate-p-ethylbenzyl,
4-hydroxybenzoate-p-propylbenzyl,
4-hydroxybenzoate-p-tert-butylbenzyl,
phenylethyl 4-hydroxybenzoate,
4-hydroxybenzoate-o-methylphenylethyl,
4-hydroxybenzoate-m-methylphenylethyl,
4-hydroxybenzoate-p-methylphenylethyl,
4-hydroxybenzoate-p-ethylphenylethyl,
4-hydroxybenzoate-p-propylphenylethyl, and
4-hydroxybenzoate-p-tert-butylphenylethyl;
   compounds having two phenolic hydroxy groups, such as, resorcin,
2-methylresorcin,
4-n-hexylresorcin,
4-n-octylresorcin,
4-tert-octylresorcin,
4-benzoylresorcin,
4-nitroresorcin,
β-resorcylic acid methyl,
β-resorcylic acid benzyl,
2-chloro-4-pentanoylresorcin,
6-chloro-4-pentanoylresorcin,
2-chloro-4-hexanoylresorcin,
6-chloro-4-hexanoylresorcin,
2-chloro-4-propanoylresorcin,
6-chloro-4-propanoylresorcin,
2,6-dichloro-4-propanoylresorcin,
6-fluoro-4-propanoylresorcin,
2-chloro-4-phenylacetylresorcin,
6-chloro-4-phenylacetylresorcin,
2-chloro-4-β-phenylpropanoylresorcin,
6-chloro-4-β-phenylpropanoylresorcin,
2-chloro-4-phenoxyacetylresorcin,
6-chloro-4-phenoxyacetylresorcin,
4-benzoyl-2-chlororesorcin,
6-chloro-4-m-methylbenzoylresorcin,
4-[1′,3′,4′,9′a-tetrahydro-6′-hydroxyspiro(cyclohexane-1,9′-[9H]-xanthene)-4′a-[2H]-yl]-1,3-benzenediol,
hydroquinone,
methyl hydroquinone,
trimethyl hydroquinone,
catechol,
4-tert-butylcatechol,
1,6-dihydroxynaphthalene,
2,7-dihydroxynaphthalene,
1,5-dihydroxynaphthalene,
2,6-dihydroxynaphthalene,
2,4-dihydroxybenzophenone,
4,4′-dihydroxybenzophenone,
2,4-dihydroxy-2′-methylbenzophenone,
2,4-dihydroxy-3′-methylbenzophenone,
2,4-dihydroxy-4′-methylbenzophenone,
2,4-dihydroxy-4′-ethylbenzophenone,
2,4-dihydroxy-4′-n-propylbenzophenone,
2,4-dihydroxy-4′-isopropylbenzophenone,
2,4-dihydroxy-4′-n-butylbenzophenone,
2,4-dihydroxy-4′-isobutylbenzophenone,
2,4-dihydroxy-4′-tert-butylbenzophenone,
2,4-dihydroxy-4′-n-pentylbenzophenone,
2,4-dihydroxy-4′-n-hexylbenzophenone,
2,4-dihydroxy-4′-n-heptylbenzophenone,
2,4-dihydroxy-4′-n-octylbenzophenone,
2,4-dihydroxy-4′-n-decylbenzophenone,
2,4-dihydroxy-2′,3′-dimethylbenzophenone,
2,4-dihydroxy-2′,4′-dimethylbenzophenone,
2,4-dihydroxy-2′,5′-dimethylbenzophenone,
2,4-dihydroxy-2′,6′-dimethylbenzophenone,
2,4-dihydroxy-3′,4′-dimethylbenzophenone,
2,4-dihydroxy-3′,5′-dimethylbenzophenone,
2,4-dihydroxy-2′,4′,6′-trimethylbenzophenone,
2,4-dihydroxy-2′-methoxybenzophenone,
2,4-dihydroxy-3′-methoxybenzophenone,
2,4-dihydroxy-4′-methoxybenzophenone,
2,4-dihydroxy-2′-ethoxybenzophenone,
2,4-dihydroxy-4′-ethoxybenzophenone,
2,4-dihydroxy-4′-n-propoxybenzophenone,
2,4-dihydroxy-4′-isopropoxybenzophenone,
2,4-dihydroxy-4′-n-butoxybenzophenone,
2,4-dihydroxy-4′-isobutoxybenzophenone,
2,4-dihydroxy-4′-n-pentyloxybenzophenone,
2,4-dihydroxy-4′-n-hexyloxybenzophenone,
2,4-dihydroxy-4′-n-heptyloxybenzophenone,
2,4-dihydroxy-4′-n-octyloxybenzophenone,
2,4-dihydroxy-4′-n-nonyloxybenzophenone,
2,4-dihydroxy-2′,3′-dimethoxybenzophenone,
2,4-dihydroxy-2′,4′-dimethoxybenzophenone,
2,4-dihydroxy-2′,5′-dimethoxybenzophenone,
2,4-dihydroxy-2′,6′-dimethoxybenzophenone,
2,4-dihydroxy-3′,4′-dimethoxybenzophenone,
2,4-dihydroxy-3′,5′-dimethoxybenzophenone,
2,4-dihydroxy-3′,4′-diethoxybenzophenone,
2,4-dihydroxy-2′,3′,4′-trimethoxybenzophenone,
2,4-dihydroxy-2′,3′,6′-trimethoxybenzophenone,
2,4-dihydroxy-3′,4′,5′-trimethoxybenzophenone, and
2,4-dihydroxy-3′,4′,5′-triethoxybenzophenone;
   bisphenol compounds, such as,
1,1-bis(4-hydroxyphenyl) ethane,
1,1-bis(4-hydroxyphenyl) propane,
1,1-bis(4-hydroxyphenyl) n-butane,
1,1-bis(4-hydroxyphenyl) n-pentane,
1,1-bis(4-hydroxyphenyl) n-hexane,
1,1-bis(4-hydroxyphenyl) n-heptane,
1,1-bis(4-hydroxyphenyl) n-octane,
1,1-bis(4-hydroxyphenyl) n-nonane,
1,1-bis(4-hydroxyphenyl) n-decane,
1,1-bis(4-hydroxy-3-methylphenyl)decane,
1,1-bis(4-hydroxyphenyl) n-dodecane,
1,1-bis(4-hydroxyphenyl)-2-methylpropane,
1,1-bis(4-hydroxyphenyl)-3-methylbutane,
1,1-bis(4-hydroxyphenyl)-3-methylpentane,
1,1-bis(4-hydroxyphenyl)-2,3-dimethylpentane,
1,1-bis(4-hydroxyphenyl)-2-ethylbutane,
1,1-bis(4-hydroxyphenyl)-2-ethylhexane,
1,1-bis(4-hydroxyphenyl)-3,7-dimethyloctane,
1,1-bis(4-hydroxyphenyl) cyclohexane,
1,1-bis(4-hydroxyphenyl)-3,3,5-trimethylcyclohexane,
1,1-bis(4-hydroxy-3-methyl)cyclohexane,
diphenolic acid,
1-phenyl-1,1-bis(4-hydroxyphenyl)methane,
2,2-bis(4-hydroxyphenyl) propane,
2,2-bis(4-hydroxyphenyl) n-butane,
2,2-bis(4-hydroxyphenyl) n-pentane,
2,2-bis(4-hydroxyphenyl) n-hexane,
2,2-bis(4-hydroxyphenyl) n-heptane,
2,2-bis(4-hydroxyphenyl) n-octane,
2,2-bis(4-hydroxyphenyl) n-nonane,
2,2-bis(4-hydroxyphenyl) n-decane,
2,2-bis(4-hydroxyphenyl) n-dodecane,
2,2-bis(4-hydroxyphenyl)-6,10,14-trimethylpentadecane,
1-phenyl-1,1-bis(4-hydroxyphenyl)ethane,
2,2-bis(4-hydroxyphenyl)methylpropionate,
2,2-bis(4-hydroxyphenyl)butylpropionate,
2,2-bis(4-hydroxy-3-methylphenyl)methylpropionate,
2,2-bis(4-hydroxyphenyl)ethylpropionate,
2,2-bis(4-hydroxyphenyl)-4-methylpentane,
2,2-bis(4-hydroxyphenyl)-4-methylhexane,
2,2-bis(4-hydroxyphenyl)hexafluoropropane,
2,2-bis(3,5-dihydroxymethyl-4-hydroxyphenyl)hexafluoropropane,
2,2-bis(4-hydroxy-3-methylphenyl)propane,
2,2-bis(4-hydroxy-3-methylphenyl)butane,
2,2-bis(4-hydroxy-3-isopropylphenyl)propane,
2,2-bis(3-sec-butylphenyl-4-hydroxy)propane,
2,2-bis(4-hydroxy-3-phenylphenyl)propane,
2,2-bis(3-tert-butyl-4-hydroxyphenyl)propane,
2,2-bis(3-fluoro-4-hydroxyphenyl)propane,
2,2-bis(3,5-dihydroxymethyl-4-hydroxyphenyl)propane,
9,9-bis(4-hydroxy-3-methylphenyl)fluorene,
1,3-bis[2-(4-hydroxyphenyl)-2-propyl]benzene,
1,4-bis[2-(4-hydroxyphenyl)-2-propyl]benzene,
3,3-bis(4-hydroxyphenyl)oxindole,
3,3-bis(4-hydroxy-3-methylphenyl)oxindole,
bis(2-hydroxyphenyl)methane,
bis(2-hydroxy-5-methylphenyl)methane,
bis(2-hydroxy-3-hydroxymethyl-5-methyl)methane,
4,4′-[1,4-phenylenebis(1-methylethylidene)]bis(2-methylphenol),
1,1-bis(4-hydroxy-3-phenylphenyl)cyclohexane,
3,3-ethyleneoxydiphenol,
1,4-bis(4-hydroxybenzoart)-3-methylbenzene,
4,4″-dihydroxy-3″-methyl-p-terphenyl,
4,4″-dihydroxy-3″-isopropyl-p-terphenyl,
2,2-dimethyl-1,3-bis(4-hydroxybenzoyloxy)propane,
2,2′-biphenol,
4,4′″-dihydroxy-p-quaterphenyl,
4,4-dihydroxydiphenyl ether,
bis(4-hydroxyphenylthioethyl)ether,
bis(4-hydroxyphenyl)sulfone,
4-benzyloxy-4′-hydroxydiphenylsulfone,
4-(4-methylbenzyloxy)-4′-hydroxydiphenylsulfone,
4-(4-ethylbenzyloxy)-4′-hydroxydiphenylsulfone,
4-(4-n-propylbenzyloxy)-4′-hydroxydiphenylsulfone,
4-(4-isopropylbenzyloxy)-4′-hydroxydiphenylsulfone,
4-(4-n-butylbenzyloxy)-4′-hydroxydiphenylsulfone,
4-(4-isobutylbenzyloxy)-4′-hydroxydiphenylsulfone,
4-(4-sec-butylbenzyloxy)-4′-hydroxydiphenylsulfone,
4-(4-tert-butylbenzyloxy)-4′-hydroxydiphenylsulfone,
4-(3-methylbenzyloxy)-4′-hydroxydiphenylsulfone,
4-(3-ethylbenzyloxy)-4′-hydroxydiphenylsulfone,
4-(3-n-propylbenzyloxy)-4′-hydroxydiphenylsulfone,
4-(3-isopropylbenzyloxy)-4′-dihydroxyphenylsulfone,
4-(3-n-butylbenzyloxy)-4′-hydroxydiphenylsulfone,
4-(3-isobutylbenzyloxy)-4′-hydroxydiphenylsulfone,
4-(3-sec-butylbenzyloxy)-4′-hydroxydiphenylsulfone,
4-(3-tert-butylbenzyloxy)-4′-hydroxydiphenylsulfone,
4-(2-methylbenzyloxy)-4′-hydroxydiphenylsulfone,
4-(2-ethylbenzyloxy)-4′-hydroxydiphenylsulfone,
4-(2-n-propylbenzyloxy)-4′-hydroxydiphenylsulfone,
4-(2-isopropylbenzyloxy)-4′-hydroxydiphenylsulfone,
4-(2-n-butylbenzyloxy)-4′-hydroxydiphenylsulfone,
4-(2-isobutylbenzyloxy)-4′-hydroxydiphenylsulfone,
4-(2-sec-butylbenzyloxy)-4′-hydroxydiphenylsulfone,
4-(2-tert-butylbenzyloxy)-4′-hydroxydiphenylsulfone,
2,4′-dihydroxydiphenylsulfone,
3,4′-dihydroxydiphenylsulfone,
4-hydroxydiphenyl sulfone,
4-methyl-4′-hydroxidiphenyl sulfone,
4-ethyl-4′-hydroxydiphenyl sulfone,
4-n-propyl-4′-hydroxydiphenyl sulfone,
4-isopropyl-4′-hydroxydiphenyl sulfone,
4-chloro-4′-hydroxydiphenyl sulfone,
4-fluoro-4′-hydroxydiphenyl sulfone,
4-chloro-2-methyl-4′-hydroxydiphenyl sulfone,
4-methoxy-4′-hydroxydiphenyl sulfone,
4-ethoxy-4′-hydroxydiphenyl sulfone,
4-n-propoxy-4′-hydroxydiphenyl sulfone,
4-isopropoxy-4′-hydroxydiphenyl sulfone,
4-n-butyloxy-4′-hydroxydiphenyl sulfone,
4-isobutoxy-4′-hydroxydiphenyl sulfone,
4-sec-butoxy-4′-hydroxydiphenyl sulfone,
4-tert-butoxy-4′-hydroxydiphenyl sulfone,
4-n-pentyloxy-4′-hydroxydiphenyl sulfone,
4-isopentyloxy-4′-hydroxydiphenyl sulfone,
4-(1-propenyloxy)-4′-hydroxydiphenyl sulfone,
4-(2-propenyloxy)-4′-hydroxydiphenyl sulfone,
4-benzyloxy-4′-hydroxydiphenyl sulfone,
4-(O-phenoxyethoxy)-4′-hydroxydiphenyl sulfone,
4-(O-phenoxypropoxyl)-4′-hydroxydiphenyl sulfone,
bis(2-allyl-4-hydroxydiphenyl)sulfone,
bis[4-hydroxy-3-(2-propenyl)phenyl]sulfone,
bis(3,5-dibromo-4-hydroxyphenyl)sulfone,
bis(3,5-dichloro-4-hydroxyphenyl)sulfone,
bis(3-phenyl-4-hydroxyphenyl)sulfone,
bis(4-hydroxy-3-n-propylphenyl)sulfone,
bis(4-hydroxy-3-methylphenyl)sulfone,
3,4-dihydroxydiphenyl sulfone,
3′,4′-dihydroxy-4-methyldiphenylsulfone,
3,4,4′-trihydroxydiphenyl sulfone,
bis(3,4-dihydroxyphenyl)sulfone,
2,3,4-trihydroxydiphenyl sulfone,
4-isopropoxy-4′-hydroxydiphenyl sulfone,
4-n-propoxy-4′-hydroxydiphenyl sulfone,
4-allyloxy-4′-hydroxydiphenyl sulfone,
4-benzyloxy-4′-hydroxydiphenyl sulfone,
4-(2-propenyloxy)-4′-hydroxydiphenyl sulfone,
3-benzyl-4-benzyloxy-4′-hydroxydiphenyl sulfone,
3-phenethyl-4-phenethyloxy-4′-hydroxydiphenyl sulfone,
3-methylbenzyl-4-methylbenzyloxy-4′-hydroxydiphenylsulfone,
4-benzyloxy-3′-benzyl-4′-hydroxydiphenylsulfone,
4-phenethyloxy-3′-phenethyl-4′-hydroxydiphenylsulfone,
4-methylbenzyloxy-3′-methylbenzyl-4′-hydroxydiphenylsulfone,
α,α′-bis{4-(p-hydroxyphenyl sulfone)phenoxy}-p-xylene,
4,4′-{oxybis(ethylene oxide-p-phenylene sulfonyl)}diphenol,
bis(4-hydroxyphenyl)sulfide,
bis(4-hydroxy-3-methylphenyl)sulfide,
bis(3,5-dimethyl-4-hydroxyphenyl)sulfide,
bis(3-ethyl-4-hydroxyphenyl)sulfide,
bis(3,5-diethyl-4-hydroxyphenyl)sulfide,
bis(4-hydroxy-3-n-propylphenyl)sulfide,
bis(3,5-di-n-propyl-4-hydroxyphenyl)sulfide,
bis(3-tert-butyl-4-hydroxyphenyl)sulfide,
bis(3,5-di-tert-butyl-4-hydroxyphenyl)sulfide,
bis(4-hydroxy-3-n-pentylphenyl)sulfide,
bis(3-n-hexyl-4-hydroxyphenyl)sulfide,
bis(3-n-heptyl-4-hydroxyphenyl)sulfide,
bis(5-tert-octyl-2-hydroxyphenyl)sulfide,
bis(2-hydroxy-3-tert-octylphenyl)sulfide,
bis(2-hydroxy-5-n-octyl-phenyl)sulfide,
bis(5-chloro-2-hydroxyphenyl)sulfide,
bis(3-cyclohexyl-4-hydroxyphenyl)sulfide,
bis(4-hydroxyphenylthioethoxy)methane,
1,5-(4-hydroxyphenylthio)-3-oxypentane, and
1,8-bis(4-hydroxyphenylthio)-3,6-dioxaoctane;
   compounds having three phenolic hydroxy groups, such as,
pyrogallol,
phloroglucinol,
phloroglucinolcarboxylic acid,
gallic acid,
octyl gallate, and
dodecyl gallate;
   trisphenol compounds, such as,
4,4′,4″-methylidine trisphenol,
4,4′,4″-methylidine tris(2-methylphenol),
4,4′-[(2-hydroxyphenyl)methylene]bis(2,3,5-trimethylphenol),
4,4′-[(4-hydroxyphenyl)methylene]bis(2-methylphenol),
4,4′-[(4-hydroxyphenyl)methylene]bis(2,6-dimethylphenol),
4,4′-[(4-hydroxy-3-methoxyphenyl)methylene]bisphenol,
4,4′-[(4-hydroxyphenyl)methylene]bis(2-cyclohexyl-5-methylphenol),
4,4′,4″-ethylidine trisphenol,
4,4′,4″-ethyridinetris(2-methylphenol),
4,4′-[(2-hydroxyphenyl)methylene]bis(2-cyclohexyl-5-methylphenol),
2,6-bis[(2-hydroxy-5-methylphenyl)methyl]-4-methylphenol,
2,4-bis[(2-hydroxy-5-methylphenyl)methyl]-6-cyclohexylphenol,
4,4′-[1-{4-[1-(4-hydroxyphenyl)-1-methylethyl]phenyl}-methylidene]bisphenol,
4,4′-[1-{4-[1-(4-hydroxyphenyl)-1-methylethyl]phenyl}-ethylidene]bisphenol,
4,4′-[1-{4-[1-(4-hydroxyphenyl)-1-methylethyl]phenyl}-propylidene]bisphenol,
4,4′-[1-{4-[1-(4-hydroxyphenyl)-1-methylethyl]phenyl}-butylidene]bisphenol,
4,4′-[1-{4-[1-(4-hydroxyphenyl)-1-methylethyl]phenyl}-pentylidene]bisphenol,
4,4′-[1-{4-[1-(4-hydroxyphenyl)-1-methylethyl]phenyl}-hexylidene]bisphenol,
4,4′-[1-{4-[1-(4-hydroxyphenyl)-1-methylethyl]phenyl}-heptylidene]bisphenol,
4,4′-[1-{4-[1-(4-hydroxyphenyl)-1-methylethyl]phenyl}-isobutylidene]bisphenol,
4,4′-[1-{4-[1-(4-hydroxyphenyl)-1-methylethyl]phenyl}-neopentylidene]bisphenol,
2,2′-[1-{4-[1-(2-hydroxyphenyl)-1-methylethyl]phenyl}-ethylidene]bisphenol,
3,3′-[1-{4-[1-(3-hydroxyphenyl)-1-methylethyl]phenyl}-ethylidene]bisphenol,
4,4′-[1-{4-[1-(3-fluoro-4-hydroxyphenyl)-1-methylethyl]phenyl}-ethylidene]bis(2-fluorophenol),
4,4′-[1-{4-[1-(3-chloro-4-hydroxyphenyl)-1-methylethyl]phenyl}-ethylidene]bis(2-chlorophenol),
4,4′-[1-{4-[1-(3-bromo-4-hydroxyphenyl)-1-methylethyl]phenyl}-ethylidene]bis(2-bromophenol),
4,4′-[1-{4-[1-(4-hydroxy-3-methylphenyl)-1-methylethyl]phenyl}-ethylidene]bis(2-methylphenol),
4,4′-[1-{4-[1-(3-ethyl-4-hydroxyphenyl)-1-methylethyl]phenyl}-ethylidene]bis(2-ethylphenol),
4,4′-[1-{4-[1-(3-tert-butyl-4-hydroxyphenyl)-1-methylethyl]-phenyl}ethylidene]bis(2-tert-butylphenol),
4,4′-[1-{4-[1-(4-hydroxy-3-trifluoromethylphenyl)-1-methylethyl]phenyl}ethylidene]bis(2-trifluoromethylphenol),
1,1-bis(4-hydroxyphenyl)-4-(4-hydroxy-α-ethyl)benzyl-cyclohexane,
4,4′-[(3-ethoxy-4-hydroxyphenyl)methylene]bisphenol,
4,4′-[(3-hydroxyphenyl)methylene]bis(2,6-dimethylphenol),
2,2′-[(4-hydroxyphenyl)methylene]bis(3,5-dimethylphenol),
4,4′-[(4-hydroxy-3-methoxyphenyl)methylene]bis(2,6-dimethylphenol),
2,2′-[(2-hydroxyphenyl)methylene]bis(3,5,6-trimethylphenol),
4,4′-[(3-hydroxyphenyl)methylene]bis(2,3,6-trimethylphenol),
4,4′-[(4-hydroxyphenyl)methylene]bis(2,3,6-trimethylphenol),
4,4′-[(3-hydroxyphenyl)methylene]bis(2-cyclohexyl-5-methylphenol),
4,4′-[(4-hydroxyphenyl-3-methoxy)methylene]bis(2-cyclohexyl-5-methylphenol),
1,1-bis(4-hydroxyphenyl)-4-hydroxyphenylcyclohexane,
4,4′-[3-(5-cyclohexyl-4-hydroxy-2-methylphenyl)-3-phenyl)propylidene]bis(2-cyclohexyl-5-methylphenol),
4,4′-[(2-hydroxyphenyl)methylene]bis(2-methylphenol),
2,4′,4″-methylidine trisphenol,
4,4′-[(2-hydroxyphenyl)methylene]bis(3-methylphenol),
4,4′-[4-(4-hydroxyphenyl)-sec-butylidene]bis(4-hydroxyphenol),
2,2′-[(3-hydroxyphenyl)methylene]bis(3,5-dimethylphenol),
4,4′-[(2-hydroxy-3-methoxyphenyl)methylene]bis(2,5-dimethylphenol),
4,4′-[(2-hydroxy-3-methoxyphenyl)methylene]bis(2,6-dimethylphenol),
2,2′-[(2-hydroxy-3-methoxyphenyl)methylene]bis(3,5-dimethylphenol),
2,2′-[(3-hydroxy-4-methoxyphenyl)methylene]bis(3,5-dimethylphenol),
2,2′-[(4-hydroxy-3-methoxyphenyl)methylene]bis(3,5-dimethylphenol),
4,4′-[(2-hydroxyphenyl)methylene]bis(2-isopropylphenol),
4,4′-[(3-hydroxyphenyl)methylene]bis(2-isopropylphenol),
4,4′-[(4-hydroxyphenyl)methylene]bis(2-isopropylphenol),
2,2′-[(3-hydroxyphenyl)methylene]bis(3,5,6-trimethylphenol),
2,2′-[(4-hydroxyphenyl)methylene]bis(3,5,6-trimethylphenol),
2,2′-[(3-ethoxy-4-hydroxyphenyl)methylene]bis(3,5-dimethylphenol),
1,1-bis(4-hydroxy-3-methylphenyl)-4-(4-hydroxyphenyl)-cyclohexane,
4,4′-[(2-hydroxy-3-methoxyphenyl)methylene]bis(2-isopropylphenol),
4,4′-[(3-hydroxy-4-methoxyphenyl)methylene]bis(2-isopropylphenol),
4,4′-[(4-hydroxy-3-methoxyphenyl)methylene]bis(2-isopropylphenol),
2,2′-[(2-hydroxy-3-methoxyphenyl)methylene]bis(3,5,6-trimethylphenol,
2,2′-[(3-hydroxy-4-methoxyphenyl)methylene]bis(3,5,6-trimethylphenol),
2,2′-[(4-hydroxy-3-methoxyphenyl)methylene]bis(3,5,6-trimethylphenol),
4,4′-[(3-ethoxy-4-hydroxyphenyl)methylene]bis(2-isopropylphenol),
2,2′-[(3-ethoxy-4-hydroxyphenyl)methylene]bis(3,5,6-trimethylphenol),
4,4′-[(3-ethoxy-4-hydroxyphenyl)methylene]bis(2,3,6-trimethylphenol),
1,1-bis(3,5-dimethyl-4-hydroxyphenyl)-4-(4-hydroxyphenyl)-cyclohexane,
4,4′-[(4-hydroxy-3-methoxyphenyl)methylene]bis(2-tert-butyl-5-methylphenol),
4,4′-[(2-hydroxyphenyl)methylene]bis(2-cyclohexylphenol),
4,4′-[(3-hydroxyphenyl)methylene]bis(2-cyclohexylphenol),
4,4′-[(3-ethoxy-4-hydroxyphenyl)methylene]bis(2-tert-butyl-6-methylphenol),
4,4′-[(3-methoxy-2-hydroxyphenyl)methylene]bis(2-cyclohexylphenol),
4,4′-[(3-hydroxy-4-methoxyphenyl)methylene]bis(2-cyclohexylphenol),
4,4′-[1-{4-[1-(3-fluoro-4-hydroxylophenyl)-1-methylethyl]-phenyl}ethylidene]bis(2-tert-butylphenol),
4,4′-[1-{4-[1-(3,5-dimethyl-4-hydroxyphenyl)-1-methylethyl]-phenyl}ethylidene]bis(2,6-dimethylphenol),
4,4′-[(3-ethoxy-4-hydroxyphenyl)methylene]bis(2-cyclohexyl-5-methylphenol),
4,4′-[(3-cyclohexyl-4-hydroxyphenyl)ethylidene]bis(2-cyclohexylphenol),
4,4′-[(5-cyclohexyl-4-hydroxy-2-methoxyphenyl)ethylidene]bis(2-cyclohexyl-5-methylphenol),
4,4′-[1-{4-[1-(3-cyclohexyl-4-hydroxyphenyl)-1-methylethyl]-phenyl}ethylidene]bis(2-cyclohexylphenol),
4,4′-[1-{4-[1-(3-fluoro-4-hydroxyphenyl)-1-methylethyl]phenyl}-ethylidene]bisphenol,
4,4′-[1-{4-[1-(3-fluoro-4-hydroxyphenyl)-1-methylethyl]phenyl}-ethylidene]bis(2-methylphenol),
4,4′-[1-{4-[1-(3-fluoro-4-hydroxyphenyl)-1-methylethyl]phenyl}-ethylidene]bis(2,6-dimethylphenol),
2,6-bis[(5-fluoro-2-hydroxyphenyl)methyl]-4-methylphenol,
2,6-bis[(3,5-dimethyl-4-hydroxyphenyl)methyl]-4-methylphenol,
2,6-bis[(4-hydroxyphenyl)methyl]-4-methylphenol,
2,6-bis[(4-hydroxyphenyl)methyl]-4-ethylphenol,
2,4-bis[(4-hydroxy-3-methylphenyl)methyl]-6-methylphenol,
2,6-bis[(4-hydroxy-3-methylphenyl)methyl]-4-methylphenol,
2,6-bis[(4-hydroxy-3-methylphenyl)methyl]-4-ethylphenol,
2,6-bis[(2-hydroxy-5-methylphenyl)methyl]-4-ethylphenol,
2,6-bis[(3,5-dimethyl-2-hydroxyphenyl)methyl]-4-methylphenol,
2,6-bis[(2,4-dimethyl-6-hydroxyphenyl)methyl]-4-methylphenol,
2,4-bis[(4-hydroxyphenyl)methyl]-6-cyclohexylphenol,
2,6-bis[(2,5-dimethyl-4-hydroxyphenyl)methyl]-3,4-dimethylphenol,
2,6-bis[(2,5-dimethyl-4-hydroxyphenyl)methyl]-4-ethylphenol,
2,6-bis[(4-hydroxy-2,3,6-trimethylphenyl)methyl]-4-methylphenol,
2,4-bis[(4-hydroxy-3-methylphenyl)methyl]-6-cyclohexylphenol,
2,6-bis[(4-hydroxy-3-methylphenyl)methyl]-4-cyclohexylphenol,
2,6-bis[(2-hydroxy-5-methylphenyl)methyl]-4-cyclohexylphenol,
2,6-bis[(4-hydroxy-2,3,5-trimethylphenyl)methyl]-4-ethylphenol,
2,4-bis[(2,5-dimethyl-4-hydroxyphenyl)methyl]-6-cyclohexylphenol,
4,4′,4″-methylidine tris(2,6-dimethylphenol),
α-(4-hydroxy-3-methylphenyl)-α,α′-bis(4-hydroxyphenyl)-1-ethyl-4-isopropylbenzene,
α′-(4-hydroxy-3-methylphenyl)-α,α-bis(4-hydroxyphenyl)-1-ethyl-4-isopropylbenzene,
α,α-bis(4-hydroxy-3-methylphenyl)-α′-(4-hydroxyphenyl)-1-ethyl-4-isopropylbenzene,
α,α′-bis(4-hydroxy-3-methylphenyl)-α-(4-hydroxyphenyl)-1-ethyl-4-isopropylbenzene,
1,1-bis(4-hydroxyphenyl)-4-[1-(4-hydroxyphenyl)-1-methylpropyl]cyclohexane,
2,6-bis[(3,5-dimethyl-4-hydroxyphenyl)methyl]-4-ethylphenol,
1,1′-bis(4-hydroxyphenyl)-4-[1-(4-hydroxyphenyl)propyl]-cyclohexane,
1,1′-bis(4-hydroxy-3-methylphenyl)-4-[1-(4-hydroxyphenyl)-propyl]cyclohexane,
1,1′-bis(3,5-dimethyl-4-hydroxyphenyl)-4-[1-(4-hydroxyphenyl)-propyl]cyclohexane,
1-(4-hydroxyphenyl)-1-[4,4-bis(4-hydroxyphenyl)cyclohexyl]-4-isopropylcyclohexane,
4,4′-[3-(2,5-dimethyl-4-hydroxyphenyl)butylene]bis(2,5-dimethylphenol),
1,3,5-tri(4-hydroxy-3-phenylphenyl)adamantane,
1,3,5-tri(3-cyclohexyl-4-hydroxyphenyl)adamantane,
2,4-bis[(3,5-dimethyl-4-hydroxyphenyl)methyl]-6-cyclohexylphenol,
2,6-bis[(2,5-dimethyl-4-hydroxyphenyl)methyl]-4-cyclohexylphenol,
2,4-bis[(3-cyclohexyl-4-hydroxyphenyl)methyl]-6-methylphenol,
2,4-bis[(4-hydroxy-2,3,5-trimethylphenyl)methyl]-6-cyclohexylphenol,
2,6-bis[(5-fluoro-2-hydroxyphenyl)methyl]-4-fluorophenol,
2,6-bis[(3-fluoro-4-hydroxyphenyl)methyl]-4-fluorophenol,
2,4-bis[(3-fluoro-4-hydroxyphenyl)methyl]-6-methylphenol,
4,4′-[3-(5-cyclohexyl-4-hydroxy-2-methylphenyl)-3-biphenyl-propylidene]bis(5-cyclohexyl-2-methylphenol),
4,4′-[3-(2,5-dimethyl-4-hydroxyphenyl)-3-phenylpropylidene]-bis(2,5-dimethylphenol),
2,4-bis[(2,5-dimethyl-4-hydroxyphenyl)methyl]-6-methylphenol,
1,1,2-tris(4-hydroxyphenyl)ethane,
1,1,3-tris(4-hydroxyphenyl)propane,
1,1,4-tris(4-hydroxyphenyl)butane,
1,2,2-tris(4-hydroxyphenyl)propane,
1,2,2-tris(4-hydroxyphenyl)butane,
1,2,2-tris(4-hydroxyphenyl)pentane,
1,2,2-tris(4-hydroxyphenyl)hexane,
1,2,2-tris(4-hydroxyphenyl)heptane,
1,2,2-tris(4-hydroxyphenyl)octane,
1,2,2-tris(4-hydroxyphenyl)-3-methylbutane,
1,2,2-tris(4-hydroxyphenyl)-3,3-dimethylbutane,
1,2,2-tris(4-hydroxyphenyl)-4,4-dimethylpentane,
1,3,3-tris(4-hydroxyphenyl)butane,
1,3,3-tris(4-hydroxyphenyl)pentane,
1,3,3-tris(4-hydroxyphenyl)hexane,
1,3,3-tris(4-hydroxyphenyl)heptane,
1,3,3-tris(4-hydroxyphenyl)octane,
1,3,3-tris(4-hydroxyphenyl)nonane,
1,4,4-tris(4-hydroxyphenyl)pentane,
1,4,4-tris(4-hydroxyphenyl)hexane,
1,4,4-tris(4-hydroxyphenyl)heptane,
1,4,4-tris(4-hydroxyphenyl)octane,
1,4,4-tris(4-hydroxyphenyl)nonane,
1,4,4-tris(4-hydroxyphenyl)decane,
1,2,2-tris(2-hydroxyphenyl)propane,
1,1,2-tris(3-hydroxyphenyl)propane,
1-(4-hydroxyphenyl)-2,2-bis(2-hydroxyphenyl)propane,
1,2,2-tris(3-fluoro-4-hydroxyphenyl)propane,
1,2,2-tris(3-chloro-4-hydroxyphenyl)propane,
1,2,2-tris(3-bromo-4-hydroxyphenyl)propane,
2,2-bis(3-ethyl-4-hydroxyphenyl)-1-(4-hydroxyphenyl)propane,
2,2-bis(3-tert-butyl-4-hydroxyphenyl)-1-(4-hydroxyphenyl)-propane,
2,2-bis(2-hydroxy-3-biphenylyl)-1-(4-hydroxyphenyl)propane,
2,2-bis(3-trifluoromethyl-4-hydroxyphenyl)-1-(4-hydroxyphenyl)-propane,
2-(3-methyl-4-hydroxyphenyl)-1,2-bis(4-hydroxyphenyl)propane,
1-(3-methyl-4-hydroxyphenyl)-2,2-bis(4-hydroxyphenyl)propane,
3-(3-methyl-4-hydroxyphenyl)-1,3-bis(4-hydroxyphenyl)butane,
1-(3-methyl-4-hydroxyphenyl)-3,3-bis(4-hydroxyphenyl)butane,
4-(3-methyl-4-hydroxyphenyl)-1,4-bis(4-hydroxyphenyl)pentane,
1-(3-methyl-4-hydroxyphenyl)-4,4-bis(4-hydroxyphenyl)pentane,
1,2-bis(3-methyl-4-hydroxyphenyl)-2-(4-hydroxyphenyl)propane,
3,3-bis(3-methyl-4-hydroxyphenyl)-1-(4-hydroxyphenyl)butane,
1,3-bis(3-methyl-4-hydroxyphenyl)-3-(4-hydroxyphenyl)butane,
4,4-bis(3-methyl-4-hydroxyphenyl)-1-(4-hydroxyphenyl)pentane,
1,4-bis(3-methyl-4-hydroxyphenyl)-4-(4-hydroxyphenyl)pentane,
1,1,2-tris(3-methyl-4-hydroxyphenyl)ethane,
1,2,2-tris(3-methyl-4-hydroxyphenyl)propane,
1,1,3-tris(3-methyl-4-hydroxyphenyl)propane,
1,3,3-tris(3-methyl-4-hydroxyphenyl)butane,
1,1,4-tris(3-methyl-4-hydroxyphenyl)butane,
1,4,4-tris(3-methyl-4-hydroxyphenyl)pentane, and
4,4′-[4-(4-hydroxyphenyl)-sec-butylidene]bis(2-methylphenol);
   compounds having four or more phenolic hydroxy groups, such as,
bis[2-hydroxy-3-(2-hydroxy-5-methylbenzyl)-5-methylphenyl]-methane,
4,6-bis[(4-hydroxyphenyl)methyl)-1,3-benzenediol,
4,4′-[(3,4-dihydroxyphenyl)methylene]bis(2,6-dimethylphenol),
4,4′-[(3,4-dihydroxyphenyl)methylene]bis(2-cyclohexyl-5-methylphenol),
4,4′-[(3,4-dihydroxyphenyl)methylene]bis(2-methylphenol),
4,4′-[(3,4-dihydroxyphenyl)methylene]bis(2,3,6-trimethylphenol),
1,1,2,2-tetrakis(4-hydroxyphenyl)ethane,
4,4′,4″,4′″-(1,1,2,2-ethanetetrayl)tetrakis(2-methylphenol),
4,4′,4″,4′″-(1,1,2,2-ethanetetrayl)tetrakis(2,6-dimethylphenol),
4,4′,4″,4′″-(1,4-phenylene)bis(methylidyne)tetrakis(2,6-dimethylphenol),
2,2-bis[4,4-bis(4-hydroxy-3-methylphenyl)cyclohexyl]propane,
2,2′-[(3,4-dihydroxyphenyl)methylene]bis(3,5-dimethylphenol),
4,6-bis[(3,5-dimethyl-4-hydroxyphenyl)methyl)-1,3-benzenediol,
2,2′-[(3,4-dihydroxyphenyl)methylene]bis(3,5,6-trimethylphenol),
4,4′-[(3,4-dihydroxyphenyl)methylene]bis(2-cyclohexylphenol),
bis[4-hydroxy-3-(2-hydroxybenzyl)-5-methylphenyl]methane,
bis[4-hydroxy-3-(3-hydroxybenzyl)-5-methylphenyl]methane,
bis[4-hydroxy-3-(4-hydroxybenzyl)-5-methylphenyl]methane,
bis[2-hydroxy-3-(2-hydroxybenzyl)-5-methylphenyl]methane,
bis[2-hydroxy-3-(3-hydroxybenzyl)-5-methylphenyl]methane,
bis[2-hydroxy-3-(4-hydroxybenzyl)-5-methylphenyl]methane,
bis[2-hydroxy-3-(3-hydroxy-4-methylbenzyl)-5-methylphenyl]-methane,
bis[2-hydroxy-3-(4-hydroxy-3-methylbenzyl)-5-methylphenyl]-methane,
bis[2-hydroxy-3-(3-hydroxy-2-methylbenzyl)-5-methylphenyl]-methane,
bis[2-hydroxy-3-(2-hydroxy-3-methylbenzyl)-5-methylphenyl]-methane,
α,α′,α″,α′″-tetrakis(4-hydroxyphenyl)-p-xylene,
bis[2-hydroxy-3-(4-hydroxy-2,3,5-trimethylbenzyl)-5-methylphenyl]methane,
bis[2-hydroxy-3-(2,5-dimethyl-3-hydroxybenzyl)-5-methylphenyl]methane,
bis[2-hydroxy-3-(2,5-dimethyl-4-hydroxybenzyl)-5-methylphenyl]methane,
bis[2-hydroxy-3-(2,5-dimethyl-5-hydroxybenzyl)-5-methylphenyl]methane,
bis[2-hydroxy-3-(3,5-dimethyl-4-hydroxybenzyl)-5-methylphenyl]methane,
bis[2-hydroxy-3-(2-hydroxy-3,4,6-trimethylbenzyl)-5-methylphenyl]methane,
bis[2-hydroxy-3-(4-hydroxy-2,3,6-trimethylbenzyl)-5-methylphenyl]methane,
4,4,4′,4′-tetrakis(4-hydroxyphenyl)bicyclohexyl,
bis[4-hydroxy-3-(5-cyclohexyl-4-hydroxy-2-methylbenzyl)-5-methylphenyl]methane,
4,4,4′,4′-tetrakis(4-hydroxy-3-methylphenyl)bicyclohexyl,
4,6-bis(3,5-dimethyl-4-hydroxyphenyl)-1,2-benzenediol
4,4,4′,4′-tetrakis(3,5-dimethyl-4-hydroxyphenyl) bicyclohexyl,
1,1-bis[5-cyclohexyl-4-hydroxy-3-(2-hydroxy-5-methylbenzyl)-phenyl]cyclohexane,
1,1-bis[5-cyclohexyl-4-hydroxy-3-(3,5-dimethyl-4-hydroxyl-benzyl)phenyl]cyclohexane,
1,1-bis[5-cyclohexyl-4-hydroxy-3-(5-cyclohexyl-4-hydroxy-2-methylbenzyl)phenyl]cyclohexane,
4,6-bis[1-(4-hydroxyphenyl)ethyl-1,3-benzenediol,
2,2-bis[4-hydroxy-3-(4-hydroxy-3-methylbenzyl)-5-methylphenyl]propane,
2,6-bis[(3,5-dimethyl-4-hydroxyphenyl)benzyl]-4-[α-methyl-(3,5-dimethyl-4-hydroxyphenyl)benzyl]phenol,
4,4,4′,4′-tetrakis(3-isopropyl-4-hydroxyphenyl) bicyclohexyl,
4,4′-bis[(3,4-dihydroxyphenyl)methylene]bis(2-isopropylphenol),
2,2′-bis[4,4-bis(4-hydroxyphenyl)cyclohexyl]propane,
2,4,6-tris(4-hydroxybenzyl)-1,3-benzenediol,
4,6-bis(3,5-dimethyl-4-hydroxybenzyl)-1,2,3-benzenetriol,
3,3′-[(2-hydroxyphenyl)methylene]bis(5-methyl-1,2-benzenediol),
2,6-bis(2,4-dihydroxybenzyl)-4-ethylphenol,
2,4-bis(2,4-dihydroxybenzyl)-6-cyclohexylphenol,
2,6-bis(5-tert-butyl-2,3-dihydroxybenzyl)-4-methylphenol,
2,4,6-tris(3,5-dimethyl-4-hydroxybenzyl)-1,2-benzenediol,
2,4,6-tris(3,5-dimethyl-2-hydroxybenzyl)-1,2-benzenediol,
2,6-bis(2,4-dihydroxybenzyl)-3,4-dimethylphenol,
2,6-bis[3-(2-hydroxy-5-methylbenzyl)-2,5-dimethyl-4-hydroxybenzyl]-3,4-dimethylphenol,
4,6-bis(α-methyl-4-hydroxybenzyl)-1,2,3-benzenetriol,
4,4′-[1-{4-[1-(3,5-bis(4-hydroxybenzyl)-4-hydroxyphenyl)-1-methylethyl]phenyl}ethylidene]bis[2,6-bis(4-hydroxybenzyl)phenol],
4,4′-[1-{4-[1-(3,5-bis(4-hydroxy-3-methylbenzyl)-4-hydroxy-phenyl)-1-methylethyl]phenyl}ethylidene]bis[2,6-bis(4-hydroxy-3-methylbenzyl)phenol],
4,4′-[1-{4-[1-(3,5-bis(3,5-dimethyl-4-hydroxybenzyl)-4-hydroxyphenyl)-1-methylethyl]phenyl}ethylidene]bis[2,6-bis(3,5-dimethyl-4-hydroxybenzyl)phenol],
4,4′-[1-{4-[1-(3,5-bis(4-hydroxy-2,3,6-trimethylbenzyl)-4-hydroxyphenyl)-1-methylethyl]phenyl}ethylidene]bis[2,6-bis(4-hydroxy-2,3,6-trimethylbenzyl)phenol],
bis[5-(2,4-dihydroxybenzyl)-4-hydroxy-3-methylphenyl]methane,
bis[3-(2,4-dihydroxybenzyl)-2,5-dimethyl-4-hydroxyphenyl]-methane,
bis[3-(2,4-dihydroxy-3-methylbenzyl)-2,5-dimethyl-4-hydroxy-phenyl]methane,
bis[5-(4-hydroxybenzyl)-2,3,4-trihydroxyphenyl]methane,
1,1-bis[5-(4-hydroxybenzoyl)-2,3,4-trihydroxyphenyl]ethane,
3,3′,5,5′-tetrakis(4-hydroxybenzyl)-4,4′-dihydroxybiphenyl,
3,3′,5,5′-tetrakis(4-hydroxy-3-methylbenzyl)-4,4′-dihydroxybiphenyl,
3,3′,5,5′-tetrakis(2-hydroxy-5-methylbenzyl)-4,4′-dihydroxybiphenyl,
3,3′,5,5′-tetrakis(3,5-dimethyl-4-hydroxybenzyl)-4,4′-dihydroxybiphenyl,
bis[3-(α,α-bis(4-hydroxy-3-methylphenyl)methyl-4-hydroxy-phenyl]methane,
bis[3,5-bis(2-hydroxy-5-methylbenzyl)-4-hydroxyphenyl]methane,
4,4′,4″-ethyridinetris{[2-(2-hydroxy-5-methyl)benzyl]-6-methylphenol},
2,2-bis[3,5-bis(2-hydroxy-5-methylphenylmethyl)phenyl]propane,
bis[3-(α,α-bis(2,5-dimethyl-4-hydroxyphenyl)methyl-4-hydroxy-phenyl]methane,
bis[5-(3,5-dimethyl-4-hydroxybenzyl)-2,3,4-trihydroxyphenyl]-methane,
bis[3-(2,3,4-trihydroxybenzyl)-2,5-dimethyl-4-hydroxyphenyl]-methane,
1,1-bis[3-(2,3,4-trihydroxybenzyl)-5-cyclohexyl-4-hydroxy-phenyl]cyclohexane,
1,8,15,22-tetranonyl-3,5,10,12,17,19,24,26-octahydroxy[1,1,1,1]-metacyclophane,
4,4′-[1-{4-[1-(3,5-bis(4-hydroxy-2-methylbenzyl)-4-hydroxy-phenyl)-1-methylethyl]phenyl}ethylidene]bis[2,6-bis(4-hydroxy-2-methylbenzyl)phenol],
4,4′-[1-{4-[1-(3,5-bis(2-hydroxy-5-methylbenzyl)-4-hydroxy-phenyl)-1-methylethyl]phenyl}ethylidene]bis[2,6-bis(2-hydroxy-5-methylbenzyl)phenol],
4,4′-[1-{4-[1-(3,5-bis(3-ethyl-4-hydroxybenzyl)-4-hydroxy-phenyl)-1-methylethyl]phenyl}ethylidene]bis[2,6-bis(3-ethyl-4-hydroxybenzyl)phenol],
4,4′-[1-{4-[1-(3,5-bis(3,5-dimethyl-2-hydroxyphenyl)-4-hydroxyphenyl)-1-methylethyl]phenyl}ethylidene]bis[2,6-bis(3,5-dimethyl-2-hydroxyphenyl)phenol],
4,4′-[1-{4-[1-(3,5-bis(4-hydroxy-3-isopropylphenyl)-4-hydroxy-phenyl)-1-methylethyl]phenyl}ethylidene]bis[2,6-bis(4-hydroxy-3-isopropylphenyl)phenol],
bis[3-(α,α-bis(3,5-dimethyl-4-hydroxyphenyl)methyl-4-hydroxy-phenyl]methane,
bis[3-(α,α-bis(5-cyclohexyl-4-hydroxy-2-methylphenyl)methyl-4-hydroxyphenyl]methane,
4,4′-[4-hydroxy-3,5-bis(2-hydroxybenzyl)methylene]bis[2,6-bis(2-hydroxybenzyl)]phenol,
4,4′-[4-hydroxy-3,5-bis(4-hydroxybenzyl)methylene]bis[2,6-bis(4-hydroxybenzyl)] phenol,
4,4′,4″-ethylidinetris[2,6-bis(2-hydroxybenzyl)phenol],
4,4′,4″-ethylidinetris[2,6-bis(4-hydroxybenzyl)phenol],
2,2-bis[3,5-bis(4-hydroxy-3-methylbenzyl)-4-hydroxyphenyl]-propane,
1,8,15,22-tetraethyl-3,5,10,12,17,19,24,26-octahydroxy[1,1,1,1]-metacyclophane,
α,α′,α″,α′″-tetrakis(3,5-dimethyl-4-hydroxyphenyl)-1,4-dimethyl-benzene,
4,4′-[1-{4-[1-(3,5-bis(2-hydroxy-5-isopropylphenyl)-4-hydroxy-phenyl)-1-methylethyl]phenyl}ethylidene]bis[2,6-bis(2-hydroxy-5-isopropylphenyl) phenol],
4,4′-[1-{4-[1-(3,5-bis(4-hydroxy-2,3,5-trimethylphenyl)-4-hydroxyphenyl)-1-methylethyl]phenyl}ethylidene]bis[2,6-bis(4-hydroxy-2,3,5-trimethylphenyl)phenol],
4,4′-[1-{4-[1-(3,5-bis(3-sec-butyl-4-hydroxyphenyl)-4-hydroxyphenyl)-1-methylethyl]phenyl}ethylidene]bis[2,6-bis(3-sec-butyl-4-hydroxyphenyl)phenol],
4,4′-[1-{4-[1-(3,5-bis(3-tert-butyl-4-hydroxyphenyl)-4-hydroxyphenyl)-1-methylethyl]phenyl}ethylidene]bis[2,6-bis(3-tert-butyl-4-hydroxyphenyl)phenol],
2,6-bis{[3-(2,4-dihydroxybenzyl)-2,5-dimethyl-4-hydroxy]-benzyl}-4-methylphenol,
1,1-bis[5-(2,4-dihydroxybenzyl)-3-cyclohexyl-4-hydroxyphenyl]-cyclohexane,
1,1-bis[5-(2,3,4-trihydroxybenzyl)-3-cyclohexyl-4-hydroxy-phenyl]cyclohexane, and
2,2-bis[4,4′,4″,4′″-tetrakis(3,5-dihydroxymethyl-4-hydroxy-phenyl)cyclohexyl]propane;
   carboxylic acids and derivatives thereof, such as,
3,5-di(α-methylbenzyl)salicylic acid,
4-(2-p-methoxyphenyloxyethoxy)salicylic acid,
4-hydroxyphenylbenzoic acid,
p-chlorobenzoic acid,
4-[2-(p-methoxyphenoxy)ethyloxy]salicylic acid,
4-[3-(p-tolylsulfonyl)propyloxy]salicylic acid,
5-[p-(2-p-methoxyphenoxyethoxy)cumyl]salicylic acid,
4-octyloxycarbonylaminosalicylic acid,
3,5-distyrene salicylic acid,
N-(p-toluenesulfonyl)-glycine,
N-(p-toluenesulfonyl)-alanine,
N-(p-toluenesulfonyl)-β-alanine,
N-phenylaminocarbonyl-glycine,
N-phenylaminocarbonyl-valine,
N-(m-tolylaminocarbonyl)-phenylalanine,
N-(m-tolylaminocarbonyl)-cysteine-S-benzyl,
N-(m-tolylaminocarbonyl)-methionine,
N-(m-tolylaminocarbonyl)-tyrosine,
N-(p-tolylaminocarbonyl)-phenylalanine,
N-(p-tolylaminocarbonyl)-cysteine-S-benzyl,
N-(p-tolylaminocarbonyl)-methionine,
N-(phenylaminocarbonyl)-methionine,
N-(p-tolylaminocarbonyl)-tyrosine,
2-O-(phenylaminocarbonyl)-mandelic acid,
2-O-(p-tolylaminocarbonyl)-mandelic acid,
2-O-(m-tolylaminocarbonyl)-mandelic acid,
2-O-(o-tolylaminocarbonyl)-mandelic acid,
2-O-(1-naphthylaminocarbonyl)-mandelic acid,
2-O-(3-isopropenyl-α,α-dimethylbenzylaminocarbonyl)-mandelic acid,
2-O-(benzylaminocarbonyl)-mandelic acid,
2-O-(phenethylaminocarbonyl)-mandelic acid,
2-O-(phenylaminocarbonyl)-lactic acid,
2-O-(p-tolylaminocarbonyl)-lactic acid,
2-O-(m-tolylaminocarbonyl)-lactic acid,
2-O-(o-tolylaminocarbonyl)-lactic acid,
2-O-(1-naphthylaminocarbonyl)-lactic acid,
2-O-(3-isopropenyl-α,α-dimethylbenzylaminocarbonyl)-lactic acid,
2-O-(benzylaminocarbonyl)-lactic acid, and
2-O-(phenethylaminocarbonyl)-lactic acid; and
   acidic phosphate ester compounds, such as,

methyl acid phosphate, ethyl acid phosphate, butyl acid phosphate, butoxyethyl acid phosphate, 2-ethylhexyl acid phosphate, isodecyl acid phosphate, isotridecyl acid phosphate, oleyl acid phosphate, tetracosyl acid phosphate, monobutyl phosphate, dibutyl phosphate, monoisodecyl phosphate, and bis(2-ethylhexyl)phosphate.

As the component (B), compounds having phenolic hydroxy groups are preferably adopted because they can effectively show the thermochromic properties. However, it is also possible to use compounds selected from the group consisting of aromatic carboxylic acids, aliphatic carboxylic acids having 2 to 5 carbon atoms, metal salts of carboxylic acids, acidic phosphoric esters and metal salts thereof, and 1,2,3-triazole and derivatives thereof.

The following is an explanation of the component (C), which is a reaction medium for reversibly causing an electron transfer reaction between the components (A) and (B) in a specific temperature range. Examples of the component (c) include: alcohols, esters, ketones, ethers, and acid amides.

When the reversibly thermochromic composition is enclosed in microcapsules and then used for a second processing step, compounds having 10 or more carbon atoms are preferably adopted so that the component (c) can be stably held in the microcapsules. That is because, if the component (c) is a low-molecular weight compound, it is liable to vaporize and leak out of the microcapsules when subjected to a high temperature treatment.

As the alcohols, it is effective to use monovalent saturated aliphatic alcohols having 10 or more carbon atoms, such as, decyl alcohol, undecyl alcohol, dodecyl alcohol, tridecyl alcohol, tetradecyl alcohol, pentadecyl alcohol, hexadecyl alcohol, heptadecyl alcohol, octadecyl alcohol, eicosyl alcohol, and dococyl alcohol.

As the esters, it is effective to use esters having 10 or more carbon atoms, such as, esters obtained from combinations of monovalent aliphatic or alicyclic ring- or aromatic ring-having carboxylic acids and monovalent aliphatic or alicyclic ring- or aromatic ring-having alcohols, esters obtained from combinations of multivalent aliphatic or alicyclic ring- or aromatic ring-having carboxylic acids and monovalent aliphatic or alicyclic ring- or aromatic ring-having alcohols, and esters obtained from combinations of monovalent aliphatic or alicyclic ring- or aromatic ring-having carboxylic acids and multivalent aliphatic or alicyclic ring- or aromatic ring-having alcohols. Examples thereof include: ethyl caprylate, octyl caprylate, stearyl caprylate, myristyl caprate, docosyl caprate, 2-ethylhexyl laurate, n-decyl laurate, 3-methylbutyl laurate, cetyl myristate, isopropyl palmitate, neopentyl palmitate, nonyl palmitate, cyclohexyl palmitate, n-butyl stearate, 2-methylbutyl stearate, 3,5,5-trinethylhexyl stearate, n-undecyl stearate, pentadecyl stearate, stearyl stearate, cyclohexylmethyl stearate, isopropyl behenate, hexyl behenate, lauryl behenate, behenyl behenate, cetyl benzoate, stearyl 4-tert-butylbenzoate, dimyristyl phthalate, distearyl phthalate, dimyristyl oxalate, dicetyl oxalate, dicetyl malonate, dilauryl succinate, dilauryl glutarate, diundecyl adipate, dilauryl azelate, di-(n-nonyl) sebacate, dineopentyl 1,18-octadecylmethylenedicarboxylate, ethylene glycol dimyristate, propylene glycol dilaurate, propylene glycol distearate, hexylene glycol dipalmitate, 1,5-pentanediol distearate, 1,2,6-hexanetriol trimyristate, 1,4-cyclohaxanediol didecyl, 1,4-cyclohaxane-dimethanol dimyristate, xylene glycol dicaprate, and xylene glycol distearate.

It is also effective to use esters of saturated fatty acids with branched aliphatic alcohols or otherwise esters of unsaturated fatty acids or branched or substituent-having saturated fatty acids with aliphatic alcohols having branched chains or 16 or more carbon atoms.

Examples of the esters include: 2-ethylhexyl butyrate, 2-ethylhexyl behenate, 2-ethylhexyl myristate, 2-ethylhexyl caprate, 3,5,5-trimethylhexyl laurate, 3,5,5-trimethylhexyl palmitate, 3,5,5-trimethylhexyl stearate, 2-methylbutyl caproate, 2-methylbutyl caprylate, 2-methylbutyl caprate, 1-ethylpropyl palmitate, 1-ethylpropyl stearate, 1-ethylpropyl behenate, 1-ethylpropyl laurate, 1-ethylpropyl myristate, 1-ethylpropyl palmitate, 2-methylpentyl caproate, 2-methylpentyl caprylate, 2-methylpentyl caprate, 2-methylpentyl laurate, 1-methylbutyl stearate, 2-methylbutyl stearate, 3-methylbutyl stearate, 2-methylbutyl behenate, 3-methylbutyl behenate, 1-methylheptyl stearate, 1-methylheptyl behenate, 1-ethylpentyl caproate, 1-ethylpentyl palmitate, 1-methylpropyl stearate, 1-methyloctyl stearate, 1-methylhexyl stearate, 1,1-dimethylpropyl laurate, 1-methylpentyl caprate, 2-methylhexyl palmitate, 2-methylhexyl stearate, 2-methylhexyl behenate, 3,7-dimethyloctyl laurate, 3,7-dimethyloctyl myristate, 3,7-dimethyloctyl palmitate, 3,7-dimethyloctyl stearate, 3,7-dimethyloctyl behenate, stearyl oleate, behenyl oleate, stearyl linoleate, behenyl linoleate, 3,7-dimethyloctyl erucate, stearyl erucate, isostearyl erucate, cetyl isostearate, stearyl isostearate, 2-methylpentyl 1,2-hydroxy-stearate, 2-ethylhexyl 18-bromostearate, isostearyl 2-ketomyristate, 2-ethylhexyl 2-fluoromyristate, cetyl butyrate, stearyl butyrate, and behenyl butyrate.

Further, for the purposes of making the composition change the color so that the color change may show a large hysteresis characteristic with regard to a color density-temperature curve and consequently of giving a temperature-dependent color-memory property to the composition, it is possible to use a carboxylic acid ester compound disclosed in JP1992-017154B. That carboxylic acid ester compound shows a ΔT value (melting point-cloud point) ranging from 5° C. to less than 50° C. Examples thereof include: a carboxylic acid ester containing a substituted aromatic ring in the molecule, an ester of a carboxylic acid containing an unsubstituted aromatic ring with an aliphatic alcohol having 10 or more carbon atoms, a carboxylic acid ester containing a cyclohexyl group in the molecule, an ester of a fatty acid having 6 or more carbon atoms with an unsubstituted aromatic alcohol or phenol, an ester of a fatty acid having 8 or more carbon atoms with a branched aliphatic alcohol, an ester of a dicarboxylic acid with an aromatic alcohol or a branched aliphatic alcohol, dibenzyl cinnamate, heptyl stearate, didecyl adipate, dilauryl adipate, dimyristyl adipate, dicetyl adipate, distearyl adipate, trilaurin, trimyristin, tristearin, dimyristin, or distearin.

Further, it is also effective to use: a fatty acid ester compound obtained from a combination of an aliphatic monohydric alcohol having an odd number not less than 9 of carbon atoms with an aliphatic carboxylic acid having an even number of carbon atoms; and a fatty acid ester compound with a total carbon number of 17 to 23 to be obtained from a combination of n-pentyl alcohol or n-heptyl alcohol with an aliphatic carboxylic acid having an even number from 10 to 16 of carbon atoms.

Examples of the fatty acid ester compound include: n-pentadecyl acetate, n-tridecyl butyrate, n-pentadecyl butyrate, n-undecyl caproate, n-tridecyl caproate, n-pentadecyl caproate, n-nonyl caprylate, n-undecyl caprylate, n-tridecyl caprylate, n-pentadecyl caprylate, n-heptyl caprate, n-nonyl caprate, n-undecyl caprate, n-tridecyl caprate, n-pentadecyl caprate, n-pentyl laurate, n-heptyl laurate, n-nonyl laurate, n-undecyl laurate, n-tridecyl laurate, n-pentadecyl laurate, n-pentyl myristate, n-heptyl myristate, n-nonyl myristate, n-undecyl myristate, n-tridecyl myristate, n-pentadecyl myristate, n-pentyl palmitate, n-heptyl palmitate, n-nonyl palmitate, n-undecyl palmitate, n-tridecyl palmitate, n-pentadecyl palmitate, n-nonyl stearate, n-undecyl stearate, n-tridecyl stearate, n-pentadecyl stearate, n-nonyl eicosanoate, n-undecyl eicosanoate, n-tridecyl eicosanoate, n-pentadecyl eicosanoate, n-nonyl behenate, n-undecyl behenate, n-tridecyl behenate, and n-pentadecyl behenate.

As the ketones, it is effective to use aliphatic ketones with a total carbon number of 10 or more. Examples thereof include: 2-decanone, 3-decanone, 4-decanone, 2-undecanone, 3-undecanone, 4-undecanone, 5-undecanone, 2-dodecanone, 3-dodecanone, 4-dodecanone, 5-dodecanone, 2-tridecanone, 3-tridecanone, 2-tetradecanone, 2-pentadecanone, 8-pentadecanone, 2-hexadecanone, 3-hexadecanone, 9-heptadecanone, 2-pentadecanone, 2-octadecanone, 2-nonadecanone, 10-nonadecanone, 2-eicosanone, 11-eicosanone, 2-heneicosanone, 2-docosanone, laurone, and stearone.

Further, examples thereof also include: aryl alkyl ketones with a total carbon number of 12 to 24, such as, n-octadecanophenone, n-heptadecanophenone, n-hexadecanophenone, n-pentadecanophenone, n-tetradecanophenone, 4-n-dodecaacetophenone, n-tridecanophenone, 4-n-undecanoacetophenone, n-laurophenone, 4-n-decanoacetophenone, n-undecanophenone, 4-n-nonylacetophenone, n-decanophenone, 4-n-octylacetophenone, n-nonanophenone, 4-n-heptylacetophenone, n-octanophenone, 4-n-hexylacetophenone, 4-n-cyclohexylacetophenone, 4-tert-butylpropiophenone, n-heptaphenone, 4-n-pentylacetophenone, cyclohexyl phenyl ketone, benzyl n-butyl ketone, 4-n-butylacetophenone, n-hexanophenone, 4-isobutylacetophenone, 1-acetonaphthone, 2-acetonaphthone, and cyclopentyl phenyl ketone.

As the ethers, it is effective to use aliphatic ethers with a total carbon number of 10 or more. Examples thereof include: dipentyl ether, dihexyl ether, diheptyl ether, dioctyl ether, dinonyl ether, didecyl ether, diundecyl ether, didodecyl ether, ditridecyl ether, ditetradecyl ether, dipentadecyl ether, dihexadecyl ether, dioctadecyl ether, decanediol dimethyl ether, undecanediol dimethyl ether, dodecanediol dimethyl ether, tridecanediol dimethyl ether, decanediol diethyl ether, and undecanediol diethyl ether.

Examples of the acid amides include: acetoamide, propionamide, butyramide, caproamide, caprylamide, capronamide, lauramide, myristamide, palmitamide, stearamide, behenamide, oleamide, erucamide, benzamide, caproanilide, caprylanilide, capric acid anilide, lauranilide, myristanilide, palmitanilide, stearanilide, behenanilide, oleanilide, erucanilide, capronic acid N-methylamide, caprylic acid N-methylamide, capric acid N-methylamide, lauric acid N-methylamide, myristic acid N-methylamide, palmitic acid N-methylamide, stearic acid N-methylamide, behenic acid N-methylamide, oleic acid N-methylamide, erucic acid N-methylamide, lauric acid N-ethylamide, myristic acid N-ethylamide, palmitic acid N-ethylamide, stearic acid N-ethylamide, oleic acid N-ethylamide, lauric acid N-butyllamide, myristic acid N-butylamide, palmitic acid N-butylamide, stearic acid N-butylamide, oleic acid N-butylamide, lauric acid N-octylamide, myristic acid N-octylamide, palmitic acid N-octylamide, stearic acid N-octylamide, oleic acid N-octylamide, lauric acid N-dodecylamide, myristic acid N-dodecylamide, palmitic acid N-dodecylamide, stearic acid N-dodecylamide, oleic acid N-dodecylamide, dilauramide, dimyristamide, dipalmitamide, distearamide, dioleamide, trilauramide, trimyristamide, tripalmitamide, tristearamide, trioleamide, succinamide, adipamide, glutaramide, malonamide, azelamide, maleamide, succinic acid N-methylamide, adipic acid N-methylamide, glutaric acid N-methylamide, malonic acid N-methylamide, azelaic acid N-methylamide, succinic acid N-ethylamide, adipic acid N-ethylamide, glutaric acid N-ethylamide, malonic acid N-ethylamide, azelaic acid N-ethylamide, succinic acid N-butylamide, adipic acid N-butylamide, glutaric acid N-butylamide, malonic acid N-butylamide, adipic acid N-octylamide, and adipic acid N-dodecylamide.

The component (C) may be a compound represented by the following formula (1):

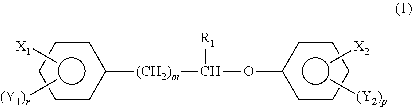

in which

R₁ is a hydrogen atom or a methyl group; m is an integer of 0 to 2; one of X₁ and X₂ is —(CH₂)ₙOCOR₂ or —(CH₂)ₙCOOR₂ and the other is a hydrogen atom provided that n is an integer of 0 to 2 and R₂ is an alkyl or alkenyl group having 4 or more carbon atoms; each of Y₁ and Y₂ is independently a hydrogen atom, an alkyl group having 1 to 4 carbon atoms, a methoxy group, or a halogen atom; and each of r and p is independently an integer of 1 to 3.

Among the compounds represented by the formula (1), those in which R₁ is a hydrogen atom are preferred because they give a reversibly thermochromic composition having a wider hysteresis width, and more preferred are those in which R₁ is a hydrogen atom and m is 0.

Among the compounds represented by the formula (1), further preferred are those represented by the following formula (2):

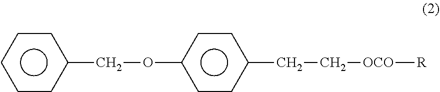

in which

R is an alkyl or alkenyl group having 8 or more carbon atoms, preferably an alkyl group having 10 to 24 carbon atoms, and more preferably an alkyl group having 12 to 22 carbon atoms.

Examples of the compounds represented by the formula (2) include: 4-benzyloxyphenylethyl octanoate, 4-benzyloxyphenylethyl nonanoate, 4-benzyloxyphenylethyl decanoate, 4-benzyloxyphenylethyl undecanoate, 4-benzyloxyphenylethyl dodecanoate, 4-benzyloxyphenylethyl tridecanoate, 4-benzyloxyphenylethyl tetradecanoate, 4-benzyloxyphenylethyl pentadecanoate, 4-benzyloxyphenylethyl hexadecanoate, 4-benzyloxyphenylethyl heptadecanoate, and 4-benzyloxyphenylethyl octadecanoate.

The component (C) also may be a compound represented by the following formula (3):

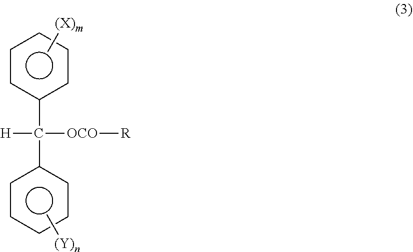

in which

R is an alkyl or alkenyl group having 8 or more carbon atoms, each of m and n is independently an integer of 1 to 3, and each of X and Y is independently a hydrogen atom, an alkyl group having 1 to 4 carbon atoms, an alkoxy group having 1 to 4 carbon atoms, or a halogen atom.

Examples of the compounds represented by the formula (3) include: 1,1-diphenylmethyl octanoate, 1,1-diphenylmethyl nonanoate, 1,1-diphenylmethyl decanoate, 1,1-diphenylmethyl undecanoate, 1,1-diphenylmethyl dodecanoate, 1,1-diphenylmethyl tridecanoate, 1,1-diphenylmethyl tetradecanoate, 1,1-diphenylmethyl pentadecanoate, 1,1-diphenylmethyl hexadecanoate, 1,1-diphenylmethyl heptadecanoate, and 1,1-diphenylmethyl octadecanoate.

The component (C) still also may be a compound represented by the following formula (4):

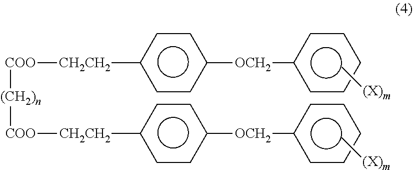

in which

X is a hydrogen atom, an alkyl group having 1 to 4 carbon atoms, a methoxy group, or a halogen atom; m is an integer of 1 to 3, and n is an integer of 1 to 20.

Examples of the compounds represented by the formula (4) include: diester of malonic acid with 2-[4-(4-chlorobenzyloxy)phenyl)]-ethanol, diester of succinic acid with 2-(4-benzyloxyphenyl)ethanol, diester of succinic acid with 2-[4-(3-methylbenzyloxy)phenyl)]ethanol, diester of glutaric acid with 2-(4-benzyloxyphenyl)ethanol, diester of glutaric acid with 2-[4-(4-chlorobenzyloxy)phenyl)]ethanol, diester of adipic acid with 2-(4-benzyloxyphenyl)ethanol, diester of pimelic acid with 2-(4-benzyloxyphenyl)ethanol, diester of suberic acid with 2-(4-benzyloxyphenyl)ethanol, diester of suberic acid with 2-[4-(3-methyl-benzyloxy)phenyl)]ethanol, diester of suberic acid with 2-[4-(4-chloro-benzyloxy)phenyl)]ethanol, diester of suberic acid with 2-[4-(2,4-dichlorobenzyloxy)phenyl)]ethanol, diester of azelaic acid with 2-(4-benzyloxyphenyl)ethanol, diester of sebacic acid with 2-(4-benzyloxy-phenyl)ethanol, diester of 1,10-decanedicarboxylic acid with 2-(4-benzyloxyphenyl)ethanol, diester of 1,18-octadecanedicarboxylic acid with 2-(4-benzyloxyphenyl)ethanol, and diester of 1,18-octadecanedicarboxylic acid with 2-[4-(2-methylbenzyloxy)phenyl)]ethanol.

Further, the component (C) may be a compound represented by the following formula (5):

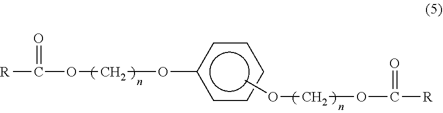

in which

R is an alkyl or alkenyl group having 1 to 21 carbon atoms, and n is an integer of 1 to 3.

Examples of the compounds represented by the formula (5) include: diester of capric acid with 1,3-bis(2-hydroxyethoxy)benzene, diester of undecanoic acid with 1,3-bis(2-hydroxyethoxy)benzene, diester of lauric acid with 1,3-bis(2-hydroxyethoxy)benzene, diester of myristic acid with 1,3-bis(2-hydroxyethoxy)benzene, diester of butylic acid with 1,4-bis(2-hydroxymethoxy)benzene, diester of isovaleric acid with 1,4-bis(hydroxymethoxy)benzene, diester of acetic acid with 1,4-bis(2-hydroxyethoxy)benzene, diester of propionic acid with 1,4-bis(2-hydroxyethoxy)benzene, diester of valeric acid with 1,4-bis(2-hydroxy-ethoxy)benzene, diester of caproic acid with 1,4-bis(2-hydroxyethoxy)-benzene, diester of carpylic acid with 1,4-bis(2-hydroxyethoxy)benzene, diester of capric acid with 1,4-bis(2-hydroxyethoxy)benzene, diester of lauric acid with 1,4-bis(2-hydroxyethoxy)benzene, and diester of myristic acid with 1,4-bis(2-hydroxyethoxy)benzene.

Still further, the component (C) may be a compound represented by the following formula (6):

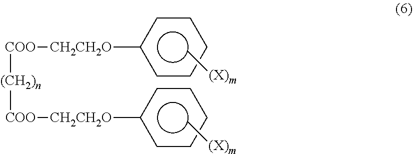

in which

X is a hydrogen atom, an alkyl group having 1 to 4 carbon atoms, an alkoxy group having 1 to 4 carbon atoms, or a halogen atom; m is an integer of 1 to 3, and n is an integer of 1 to 20.

Examples of the compounds represented by the formula (6) include: diester of succinic acid with 2-phenoxyethanol, diester of suberic acid with 2-phenoxyethanol, diester of sebacic acid with 2-phenoxyethanol, diester of 1,10-decanedicarboxylic acid with 2-phenoxyethanol, and diester of 1,18-octadecanedicarboxylic acid with 2-phenoxyethanol.

Furthermore, the component (C) may be a compound represented by the following formula (7):

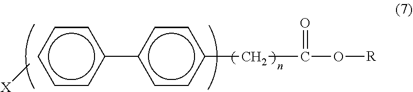

in which

R is an alkyl group having 4 to 22 carbon atoms, a cycloalkyl alkyl group, a cycloalkyl group, or an alkenyl group having 4 to 22 carbon atoms; X is a hydrogen atom, an alkyl group having 1 to 4 carbon atoms, an alkoxy group having 1 to 4 carbon atoms, or a halogen atom; and n is 0 or 1.

Examples of the compounds represented by the formula (7) include: decyl 4-phenylbenzoate, lauryl 4-phenylbenzoate, myristyl 4-phenylbenzoate, cyclohexylethyl 4-phenylbenzoate, octyl 4-biphenylacetate, nonyl 4-biphenylacetate, decyl 4-biphenylacetate, lauryl 4-biphenylacetate, myristyl 4-biphenylacetate, tridecyl 4-biphenylacetate, pentadecyl 4-biphenylacetate, cetyl 4-biphenylacetate, cyclopentyl 4-biphenylacetate, cyclohexylmethyl 4-biphenylacetate, hexyl 4-biphenylacetate, and cyclohexylmethyl 4-biphenylacetate.

Still furthermore, the component (C) may be a compound represented by the following formula (8):

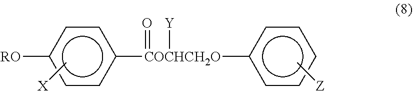

in which

R is an alkyl group having 3 to 18 carbon atoms or an aliphatic acyl group having 3 to 18 carbon atoms; X is a hydrogen atom, an alkyl group having 1 to 3 carbon atoms, an alkoxy group having 1 or 2 carbon atoms, or a halogen atom; Y is a hydrogen atom or a methyl group; and Z is a hydrogen atom, an alkyl group having 1 to 4 carbon atoms, an alkoxy group having 1 or 2 carbon atoms, or a halogen atom.

Examples of the compounds represented by the formula (8) include: phenoxyethyl 4-butoxybenzoate, phenoxyethyl 4-pentyloxy-benzoate, phenoxyethyl 4-tetradecyloxybenzoate, an ester of phenoxyethyl 4-hydroxybenzoate and dodecanoic acid, and a dodecyl ether of phenoxyethyl vanilliate.

Yet also, the component (C) may be a compound represented by the following formula (9):

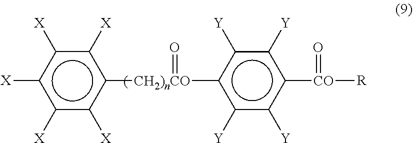

in which

R is an alkyl group having 4 to 22 carbon atoms, an alkenyl group having 4 to 22 carbon atoms, a cycloalkylalkyl group, or a cycloalkyl group; X is a hydrogen atom, an alkyl group, an alkoxy group, or a halogen atom; Y is a hydrogen atom, an alkyl group, an alkoxy group, or a halogen atom; and n is 0 or 1.

Examples of the compounds represented by the formula (9) include: a benzoic acid ester of octyl 4-hydroxybenzoate, a benzoic acid ester of decyl 4-hydroxybenzoate, a 4-methoxybenzoic acid ester of heptyl 4-hydroxybenzoate, a 2-methoxybenzoic acid ester of dodecyl 4-hydroxybenzoate, and a benzoic ester of cyclohexylmethyl 4-hydroxybenzoate.

Yet further, the component (C) may be a compound represented by the following formula (10):

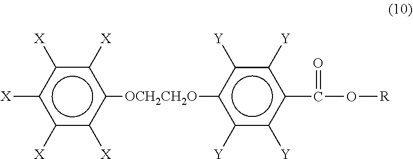

in which

R is an alkyl group having 3 to 18 carbon atoms, a cycloalkylalkyl group having 6 to 11 carbon atoms, a cycloalkyl group having 5 to 7 carbon atoms, or an alkenyl group having 3 to 18 carbon atoms; X is a hydrogen atom, an alkyl group having 1 to 4 carbon atoms, an alkoxy group having 1 to 3 carbon atoms, or a halogen atom; Y is a hydrogen atom, an alkyl group having 1 to 4 carbon atoms, a methoxy group, an ethoxy group, or a halogen atom.

Examples of the compounds represented by the formula (10) include: phenoxyethyl ether of nonyl 4-hydroxybenzoate, phenoxyethyl ether of decyl 4-hydroxybenzoate, phenoxyethyl ether of undecyl 4-hydroxybenzoate, and phenoxyethyl ether of dodecyl vanilliate.

Yet furthermore, the component (C) may be a compound represented by the following formula (11):

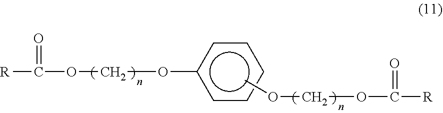

in which

R is a cycloalkyl group having 3 to 8 carbon atoms or a cycloalkylalkyl group having 4 to 9 carbon atoms, and n is an integer of 1 to 3.

Examples of the compounds represented by the formula (11) include: diester of cyclohexanecarboxylic acid with 1,3-bis(2-hydroxy-ethoxy)benzene, diester of cyclohexanepropionic acid with 1,4-bis(2-hydroxyhydroxyethoxy)benzene, and diester of cyclohexanepropionic acid with 1,3-bis(2-hydroxyethoxy)benzene.

Still yet furthermore, the component (C) may be a compound represented by the following formula (12):

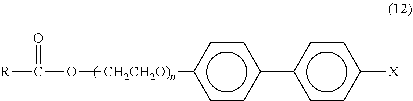

in which

R is an alkyl group having 3 to 17 carbon atoms, a cycloalkyl group having 3 to 8 carbon atoms, or a cycloalkylalkyl group having 5 to 8 carbon atoms; X is a hydrogen atom, an alkyl group having 1 to 5 carbon atoms, a methoxy group, an ethoxy group, or a halogen atom; and n is an integer of 1 to 3.

Examples of the compounds represented by the formula (12) include: diester of 4-phenylphenol ethylene glycol ether and cyclohexanecarboxylic acid, diester of 4-phenylphenol diethylene glycol ether and lauric acid, diester of 4-phenylphenol triethylene glycol ether and cyclohexanecarboxylic acid, diester of 4-phenylphenol ethylene glycol ether and octanoic acid, diester of 4-phenylphenol ethylene glycol ether and nonanoic acid, diester of 4-phenylphenol ethylene glycol ether and decanoic acid, and diester of 4-phenylphenol ethylene glycol ether and myristic acid.

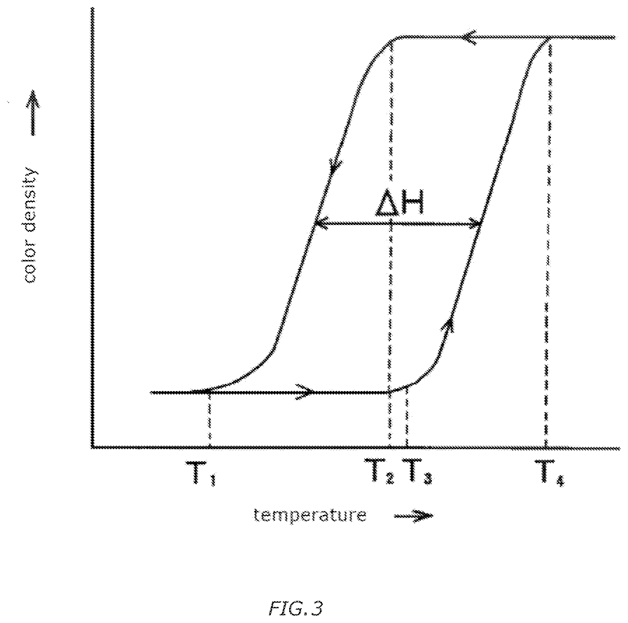

In addition, it is also possible to adopt a heat color-developing type reversibly thermochromic composition (whose color is developed by heating and lost by cooling) containing, as the electron-accepting compound, a specific alkoxyphenol compound having straight chain- or side chain-alkyl group having 3 to 18 carbon atoms (JP1999-129623A and JP1999-005973A), a specific hydroxybenzoic ester (JP2001-105732A), or a gallic ester (JP1976-044706B, JP 2003-253149A) (see, FIG. 3).

The reversibly thermochromic composition is a compatible mixture indispensably comprising the above components (A), (B) and (C), and the ratios thereof depend on the concentration, discoloration temperature, discoloration mode and kind of each component. However, the component ratios generally giving desired characteristics are, as for the component (B), in the range of 0.1 to 100, preferably 0.1 to 50, more preferably 0.5 to 20, and as for the component (C), in the range of 5 to 200, preferably 5 to 100, more preferably 10 to 100 (in which all the above ratios are in terms of weight part) based on 1 weight part of the component (A).

Further, it is also possible to add various photostabilizers into the reversibly thermochromic composition. The photostabilizers are incorporated for the purpose of preventing photodegradation of the composition containing the components (A), (B) and (C), and the amount thereof is 0.3 to 24 mass %, preferably 0.3 to 16 mass % based on the 1 mass % of the component (A). Among the photostabilizers, UV absorbers effectively cut off UV rays in sunlight or the like so as to prevent the component (A) from photodegradation in the excited state caused by photoreactions. Other photostabilizers such as oxidation inhibitors, singlet oxygen quenchers, superoxide anion quenchers, and ozone quenchers are capable of inhibiting photo-oxidation reactions. The photostabilizers may be employed singly or in combination of two or more.

In the present invention, the microcapsules have a specific structure, which is expressed by a mean particle size (X) of the microcapsules contained in the microcapsule pigment or in the ink composition and a mean cross-sectional membrane thickness (Y) determined according to an image analysis.

As the mean particle size, the present invention adopts a mean particle diameter (median size diameter) based on the volume.

The mean particle size can be determined in an optimal manner such as an analysis by use of a laser diffraction/scattering-type particle size distribution analyzer, for example, a laser diffraction particle size distribution analyzer LA-300 (product name, manufactured by HORIBA, Ltd.) with calibration based on a direct measurement.

Examples of the direct measurement for calibration include:

(i) image analysis, in which the (two-dimensional) area of each particle is measured from a microscopic image and thereby each corresponding diameter is determined; and
(ii) coulter method (electrical sensing zone method), which comprises the steps of: applying a constant current to a fine aperture of the detector in a coulter counter, measuring impedance change caused when each particle passes through the aperture, and determining each corresponding diameter from the measure impedance change.

On the basis of the value obtained by those method, the measurement result of the laser analysis is calibrated.

The mean particle size measurement according to the image analysis comprises, for example, the steps of: determining the area of each particle by use of an image analysis type particle size distribution measuring software “Mac-View” (product name, manufactured by Mountech Co., Ltd.); calculating a projected area equivalent circle diameter (Heywood diameter) from the area of each particle; and determining the mean particle diameter of particles equivalent to equal volume spheres based on the calculated values.

Here, it is noted that the mean particle size measurement according to the coulter method can be used when all or most of the particles have diameters more than 0.2 μm. In that case, the mean particle size can be measured by use of a particle size distribution analyzer Multisizer 4e (product name, manufactured by Beckman-Coulter, Inc.).

In the present invention, the microcapsule pigment contained in the ink composition has a specific mean cross-sectional membrane thickness (Y), which can be determined by image-analyzing the cross-sectional image of the microcapsules in the frozen state. Specifically, the determination process comprises, for example, the steps of:

(i) freezing a dispersion, such as an aqueous dispersion, of the microcapsule pigment;
(ii) preparing a thin section sample with a microtome;
(iii) observing the obtained thin section sample with a transmission electron microscope, such as HT7700 (product name, manufactured by Hitachi High-Tech Corporation), in the observation field where about 100 to 200 microcapsules are seen;
(iv) measuring, as for each microcapsule in the observation field, the area surrounded by the outer circumference of the cross-sectional membrane and that surrounded by the inner circumference of the cross-sectional membrane;
(v) calculating the outer and inner section diameters from the measured areas of each microcapsule;
(vi) calculating, as for all the microcapsules in the observation field, the cross-sectional membrane thicknesses according to the formula:

cross-sectional membrane thickness=(outer section diameter−inner section diameter)/2; and

averaging the calculated thicknesses to determine the mean cross-sectional membrane thickness.

In the above steps (iv) and (v), the outer and inner section diameters can be obtained by use of the aforementioned image analysis software.

It is noted that the calculation of mean cross-sectional membrane thickness in the present invention is attributed to the microcapsules whose cross-sectional membrane thicknesses can be measured and calculated in the above steps (iv) and (v).

In the present invention, the cross-sectional membrane thickness by no means simply corresponds to the thickness of microcapsule membrane but is a parameter different from the membrane thickness. It is generally very difficult to measure the thickness of microcapsule membrane. That is because, in order to directly observe the membrane thickness, it is necessary to observe a cross-section passing through the center of microcapsule. However, as for all the microcapsules having a size distribution, it is difficult to obtain cross-sections satisfying that condition. In view of that, the present invention adopts the cross-sectional membrane thickness in place of the thickness of microcapsule membrane. The cross-sectional membrane thickness is not identical with the thickness of microcapsule membrane because the sections formed by preparing the thin section sample seldom pass through the centers of the sectioned microcapsules. Moreover, since the microcapsules actually have a size distribution, it is further difficult to measure the size diameters and the membrane thicknesses of the microcapsules.

On the other hand, however, the present invention is achieved by finding that the ink composition shows excellent effects when the above parameter and the mean particle size satisfy particular conditions.

In the first place, the microcapsules contained in the ink composition of the invention have a volume-based mean particle size (X) of 0.1 to 2 μm, preferably 0.3 to 1.5 μm. If the microcapsules have too small a volume-based mean particle size (X), the color density generally tends to be lowered. On the other hand, if it is too large, the microcapsules may be precipitated and/or the inkjet performance may be impaired. Accordingly, it is necessary to pay attention to the mean particle size. Thus, the volume-based mean particle size (X) in the above range can make it possible to keep favorable color density and good inkjet performance.

In order to keep the inkjet performance and the stability thereof, the ink composition preferably contains coarse microcapsules in a small amount. Specifically, the content ratio of microcapsules having diameters of 5 μm or more (hereinafter, often referred to as “large particle ratio”) is preferably 1 volume % or less based on the total volume of the microcapsules in the microcapsule pigment.

The mean cross-sectional membrane thickness (Y) is in the range of 0.02 to 0.4 μm, preferably 0.02 to 0.3 μm, more preferably 0.03 to 0.3 μm. The mean cross-sectional membrane thickness (Y) in the proper range makes it possible to obtain a reversibly thermochromic microcapsule pigment excellent in balance between the durability and the color density.

Further, in the microcapsules contained in the ink composition of the Invention, the mean particle size (X) and the mean cross-sectional membrane thickness (Y) have a ratio Y/X satisfying preferably the following formula (1), more preferably the following formula (1a), further preferably the following formula (1b), furthermore preferably the following formula (1c). In addition, the ratio Y/X preferably satisfies the following formula (2), more preferably the following formula (2a). The ratio Y/X in the proper range makes it possible to obtain a reversibly thermochromic microcapsule pigment excellent in balance between the durability and the color density.

Y/X<0.3 (1),

Y/X<0.25 (1a),

Y/X<0.2 (1b),

0.02<Y/X (2),

0.03<Y/X (2a), and

0.04<Y/X (2b).

### [Production Process of Microcapsules]

The microcapsule pigment used in the Ink composition of the invention comprises microcapsules in which a reversibly thermochromic composition containing the aforementioned components (A), (B) and (C) is enclosed with a membrane.

Since the reversibly thermochromic composition is enclosed in microcapsules, it becomes possible to produce a chemically and physically stable pigment. Further, even under various conditions, the reversibly thermochromic composition can keep the same constitution and can show the same effect.

The method of micro-encapsulation can be selected from known processes, such as, interfacial polymerization of isocyanate type resins, in situ polymerization of melamine-formalin type resins, submerged coat hardening, phase separation from an aqueous solution, phase separation from an organic solvent, melt dispersion cooling, aerial suspension coating and spray drying. The method is optimally selected according to the use purpose. Further, depending on the purpose, it is possible to further form a secondary resin membrane for enhancing the durability or to modify the surface characteristics for practical use.

In the present invention, the mean particle size (X) and the mean cross-sectional membrane thickness (Y) of the microcapsules contained in the microcapsule pigment are required to satisfy the specific conditions. In order to satisfy the specific conditions, it is necessary to control the conditions for producing the microcapsules.

As described above, there are many methods for producing the microcapsules. Accordingly, the proper conditions are changed according to the method. Further, the conditions also depend on what ingredients and components are adopted to constitute the reversibly thermochromic composition and the microcapsule membrane.

Therefore, generally in the process for producing the microcapsules of the Invention, the production conditions are changed so as to plot a calibration curve so that the optimal conditions may be beforehand determined.

For example, when the microcapsules are produced by the interfacial polymerization method, the mean particle size (X) and the mean cross-sectional membrane thickness (Y) of the microcapsules are changed according to various conditions, such as, polymerization temperature, polymerization time, blending ratio between the reversibly thermochromic composition and the membrane material, and stirring speed of the reaction liquid. In view of that, only one of those parameters is changed, then the microcapsules are produced, and the mean particle size (X) and the mean cross-sectional membrane thickness (Y) thereof are measured. This procedure is repeated several times to plot a calibration curve. If the production conditions cannot be determined from only the obtained calibration curve, another parameter is changed to plot another calibration curve. In this way, it is possible to produce microcapsules having a desired mean particle size (X) and a desired mean cross-sectional membrane thickness (Y).

### [Inkjet Printer Ink Composition]

The inkjet printer ink composition according to the present invention comprises the reversibly thermochromic microcapsule pigment, water, and a polyalcohol organic solvent.

The content ratio of the reversibly thermochromic microcapsule pigment is preferably 3 to 30 mass %, more preferably 5 to 30 mass % based on the total mass of the ink composition. The microcapsule pigment having a content ratio in the above range makes it possible to realize both good inkjet performance and excellent color development of printed images.

The ink composition contains a polyalcohol organic solvent, which mainly has the function of keeping moisture.

Examples of the polyalcohol organic solvent useable in the ink composition include: glycerin, alkanediols and glycol ethers. Examples of the alkanediols include: 1,2-alkanediols, such as, 1,2-ethanediol, 1,2-propanediol, 1,2-butanediol, 1,2-pentanediol, 1,2-hexanediol, 1,2-heptanediol, and 1,2-octanediol; 1,3-alkanediols, such as, 1,3-propanediol, 1,3-butanediol, 1,3-pentanediol, 1,3-hexanediol, 1,3-heptanediol, and 1,3-octanediol; and other diols, such as, 2-methyl-1,3-propanediol, 2,2-dimethyl-1,3-propanediol, 2-ethyl-1,3-propanediol, 2,2-diethyl-1,3-propanediol, 2-ethyl-2-methyl-1,3-propanediol, 2-butyl-2-ethyl-1,3-propanediol, 2-ethyl-1,3-hexanediol, 3-methyl-1,5-pentanediol, 2,5-hexanediol, and 2,3-dimethyl-1,4-butanediol. Examples of the glycol ethers include: ethylene glycol ethers, such as, ethylene glycol monomethyl ether, diethylene glycol, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, tetraethylene glycol monobutyl ether, ethylene glycol dimethyl ether, diethylene glycol dimethyl ether, triethylene glycol dimethyl ether, tetraethylene glycol dimethyl ether, ethylene glycol diethyl ether, diethylene glycol diethyl ether, triethylene glycol diethyl ether, ethylene glycol ethylmethyl ether, diethylene glycol ethylmethyl ether, and triethylene glycol ethylmethyl ether; and propylene glycol ethers, such as, propylene glycol monomethyl ether, dipropylene glycol monomethyl ether, tripropylene glycol monomethyl ether, propylene glycol monoethyl ether, dipropylene glycol monoethyl ether, and tripropylene glycol monoethyl ether.

In consideration of preventing the ink composition from drying and clogging the nozzle and of preventing the ingredients enclosed in the microcapsules from oozing out into the ink composition, the polyalcohol organic solvent used in the ink composition is preferably glycerin or an alkanediol, more preferably glycerin, 1,2-ethanediol or 1,3-butanediol.

The content ratio of the polyalcohol organic solvent is preferably 5 to 60 mass %, more preferably 10 to 60 mass %, further preferably 20 to 60 mass %, furthermore preferably 30 to 50 mass %, based on the total mass of the ink composition. Two or more kinds of polyalcohol organic solvents may be used together.

### (Polyether Phosphate Ester)

The ink composition preferably further contains a polyether phosphate ester, which has the function of inhibiting the microcapsule pigment from aggregating to enhance dispersibility of the pigment and consequently to improve fluidity and inkjet suitability of the ink composition.

The polyether phosphate ester may be an alkali metal salt, an ammonium salt or an alkanolamine salt.

Examples of the polyether phosphate ester include the following commercially available products: PLYSURF Series (product name, manufactured by DKS Co. Ltd.), such as, PLYSURF A212C, A215C, A208F, M208F, A208N, A208B, A219B, DB-01, A210D, and AL; PHOSPHANOL Series ([trademark], manufactured by TOHO Chemical Industry Co., Ltd.), such as, PHOSPHANOL 2P, ML-200, GF-185, BH-650, ED-200, RA-600, ML-220, ML-240, RD-510Y, RS-410, RS-610, RS-710, RL-210, RL-310, RB-410, RD-710, RP-710, LF-200, RM-410, RM-510, SP-212, CP-120, 720, SC-6103, RD-720, LP-700, LP-500, and LB-400; Anstex Series ([trademark], manufactured by TOHO Chemical Industry Co., Ltd.), such as, Anstex AK-25, AK-25B, SM-172, GF-339, GF-199, ML-200, and GF-185; and DISPARLON AQ-320 and DISPARLON AQ-330 (product name, manufactured by Kusumoto Chemicals, Ltd.). However, those examples by no means restrict the polyether phosphate ester usable in the ink composition. Two or more kinds of polyether phosphate esters may be used in combination.

The content ratio of the polyether phosphate ester is preferably 1 to 10 mass %, more preferably 1 to 5 mass % based on the total mass of the ink composition. The polyether phosphate ester in the above content range makes it possible to keep good dispersibility of the microcapsule pigment and, at the same time, to prevent the ingredients enclosed in the microcapsules from oozing out into the ink.

### (Additives)

The ink composition may further contain any additives, if necessary. Examples of the additives include: 2-pyrrolidone, polyvinyl-pyrrolidone, urethane resin, styrene-butadiene resins, alkyd resin, sulfonamide resin, maleic acid resin, polyvinyl acetate resin, ethylene-vinyl acetate resin, vinyl chloride-vinyl acetate resin, styrene-maleic ester copolymer, styrene-acrylonitrile resin, cyanate-modified polyalkylene glycol, ester gum, xylene resin, urea resin, urea aldehyde resin, phenolic resin, alkylphenolic resin, terpene phenolic resin, rosin resins and water-added products thereof, rosin phenolic resin, polyvinyl alkyl ether, polyamide resin, polyolefin resin, nylon resin, polyester resin, cyclohexanone resin, water-soluble inorganic salts, silicone surfactants, fluorine-containing surfactants, and sulfosuccinic acid surfactants.

Further, the ink composition may contain known additives, such as, preservatives, corrosion inhibitors, fungicides, oxidation inhibitors, humectants, UV absorbers, chelating agents, pH adjusters, antifoaming agents, and viscosity modifiers.

Examples of the preservatives or fungicides include: carbolic acid, sodium salt of 1,2-benzthiazoline3-one, sodium benzoate, sodium dehydroacetate, potassium sorbate, propyl paraoxybenzoate, and 2,3,5,6-tetrachloro-4-(methylsulfonyl)pyridine. Examples of the corrosion inhibitors include: benzotriazole and tolyltriazole. Examples of the humectants include: saponin and the like, urea, sorbit, mannit, sucrose, glucose, reduced starch hydrolysate, and sodium pyrophosphate. Examples of the pH adjusters include: acidic substances, such as, hydrochloric acid, sulfuric acid, nitric acid, phosphoric acid, carbonic acid, boric acid, lactic acid, citric acid, tartaric acid, and malic acid; and basic substances, such as, sodium hydroxide, potassium hydroxide, sodium carbonate, ammonia, sodium hydrogenphosphate, and potassium hydrogenphosphate. Further, alkanolamines such as monoethanolamine, diethanolamine and triethanolamine are also usable as the basic substances. The basic substances can be also employed as neutralizers for the polyether phosphate ester.

The ink composition has a viscosity of preferably 2 to 30 mPa-s, more preferably 2 to 20 mPa·s. The viscosity in the above range improves the inkjet performance and makes it easy to form images of rich color development and high resolution.

Here, it is noted that the viscosity in the present invention can be measured under the conditions of 20° C. and 30 rpm with, for example, a TVB-M viscometer of L-shaped rotor (product name, manufactured by TOKI SANGYO CO., LTD.).

The ink composition has a surface tension of preferably 20 to 50 mN/m, more preferably 20 to 35 mN/m. The surface tension in the above range enhances osmosis of the composition and consequently promote drying of printed images.

Here, it is noted that the surface tension in the present invention is measured at 20° C. with a platinum plate according to the vertical plate method. As the measuring apparatus, it is possible to adopt a surface tensiometer manufactured by Kyowa Interface Science Co., Ltd.

The ink composition has a pH value of preferably 4 to 8, more preferably 5 to 7, at 20° C. The pH value in the above range can improve temporal stability of the ink composition.

The aqueous ink composition according to the present invention can be produced by use of various mixers, such as, a propeller agitator, a homodisper and a homomixer, and various dispersers, such as, a bead mill.

Specifically, the ink composition can be produced by the steps of: mixing the reversibly thermochromic microcapsule pigment, water, and the polyalcohol organic solvent to prepare a dispersion of the reversibly thermochromic microcapsule pigment; and then adding additives, such as the polyether phosphate ester, into the dispersion.

The ink composition of the present invention is used in inkjet printers.

### [Inkjet Printer]

Examples of the inkjet printers include: an apparatus comprising

an ink container in which the above ink composition is stored,

a printer head,

an ink-supplying channel through which the ink composition is supplied to the printer head, and

an ink-recovering channel through which the ink composition not ejected from a nozzle (ink-discharging port) is returned from the printer head to the above ink-supplying channel; and equipped with a mechanism by which

the ink composition is circulated through the ink-supplying channel, the printer head and the ink-recovering channel.

Since circulated in the above inkjet printer, the ink composition is kept from stagnating and aggregating in the channels (i.e., ink-supplying and ink-recovering channels) or in the printer head so as to improve inkjet ejection from the nozzle of the printer head.

In more consideration of inhibiting aggregation of the microcapsule pigment, the printer head preferably comprises another channel through which the ink composition is circulated even in the printer head.

If the printer head has the channel through which the ink composition is circulated, it becomes easy to inhibit the ink composition from stagnating and aggregating in the printer head because the composition is circulated in the printer head.

In addition to the above mechanism, the inkjet printer may be equipped with other mechanisms such as a degassing mechanism and a heating mechanism.

As the inkjet method of the inkjet printer, any of known methods can be adopted. Examples of known inkjet method include: charge control method, in which the ink is ejected by use of electrostatic attraction; piezo method, in which the ink composition is ejected by use of deformation of a piezo element (piezoelectric element) caused by applying voltage; acoustic inkjet method, in which acoustic beams converted from electric signals are applied to the ink so as to eject the ink by use of the radiation pressure; and thermal inkjet (bubble-jet) method, in which the ink is heated to form bubbles and thereby ejected by use of pressure generated by the bubbles. Since the reversibly thermochromic ink composition changes the color according to the temperature, the temperature of the composition preferably changes a little. Accordingly, piezo method and acoustic inkjet method are preferred because they change the temperature relatively in a small degree. However, thermal inkjet method can be adopted by controlling the temperature at which the ink composition changes the color.

The nozzle in the printer head has an inner diameter capable of smoothly ejecting the ink composition. In consideration of improving the color development and resolution of printed Images, the inner diameter is preferably 10 to 100 μm, more preferably 10 to 50 μm, further preferably 10 to 30 μm.

If the ink composition contain a radical-polymerizable compound and/or a radical polymerization initiator, the ink jet printer is preferably provided with a UV irradiation unit.

When images printed in the above ink composition are irradiated with UV light, the radical-polymerizable compound is polymerized and thereby the radical-polymerizable compound is rapidly fixed on the printed surfaces to enhance fixation of the printed images.

Further, the ink container may have a mechanism by which an ink cartridge is installed. The cartridge contains the ink composition.

The inkjet printer according to an embodiment of the present invention will be explained with reference to the drawing.

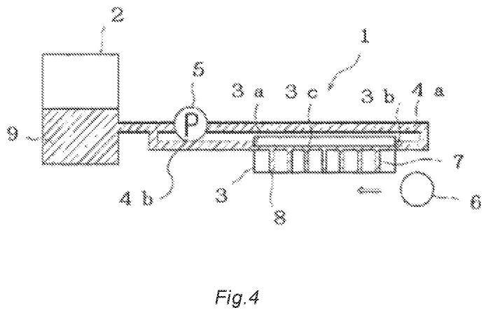

FIG. 4 is a schematic sectional view showing an example of constitution of an inkjet printer equipped with an ink-circulating mechanism. FIG. 4 shows an ink-supplying unit 1 comprising: an ink container 2, a printer head 3, an ink-supplying channel 4a, a pump 5, a wiping means 6, and an ink-recovering channel 4b (channel part positioned on the left side of the printer head 3) through which the ink is returned from the printer head to the ink-supplying channel 4a so as to circulate the ink composition.

The printer head 3 has a surface on which plural nozzles 7 having ink-discharging ports 8 are formed, and the ink composition 9 is ejected from those nozzles. Specifically, the ink composition 9 introduced into the nozzles 7 is pushed out by the action of piezoelectric elements and thereby ejected from the ink-discharging ports 8 of the nozzles 7. The printer head 3 also has: an ink-inlet 3b through which the ink composition is loaded from the ink-supplying channel 4a; an ink-outlet 3a through which the composition is drained into the ink-recovering channel 4b; and an inner channel 3c through which the plural nozzles 7, the ink-inlet 3b, and the ink-outlet 3a are connected. The density of the nozzles 7 on the printer head is, for example, 600 npi (nozzle per inch) or 2400 npi.

The ink-inlet 3b and the ink-outlet 3a in the printer head are connected through an ink channel, and thereby they form an ink circulating path through which the ink composition 9 is circulated. In FIG. 4, the ink-supplying channel 4a, the inner channel 3c in the printer head 3 and the ink-recovering channel 4b form a circular path through which the ink composition 9 is circulated. While printing is stopped, it is preferred to circulate the ink composition 9 through the circular path so as to prevent the microcapsule pigment in the ink composition 9 from precipitating or aggregating in the printer head 3. The ink-supplying channel 4a and the ink-recovering channel 4b may be pipes having diameters of 1 to 10 mm, and the material thereof may be silicon-containing resins. The circular path can be made to have a lap length of 800 mm to 10 m, preferably 1 to 9 m, more preferably 3 to 8 m.

The pump 5 is placed in the ink-supplying channel 4a on the upstream of the printer head 3, so as to supply the ink composition 9 to the printer head 3. The ink composition 9 is thus suppled to the printer head 3 and thereby circulated through the circular path, and accordingly the ink composition 9 in the inner channel 3c of the printer head 3 is made to flow. In this way, it becomes possible to prevent the microcapsule pigment in the ink composition 9 from precipitating or aggregating in the printer head 3.

While the inkjet printer is working, the ink composition is preferably circulated. On the other hand, while the printer is stopped, it is preferred to cover the discharging ports of the nozzles with caps not shown in the drawing and also to circulate the ink composition.

By use of the above inkjet printer, the ink composition can be ink-jetted onto any object, such as, paper, synthesized paper, coat paper, plastic sheets, objects made of plastics, wood, metals and glass, cloth, and non-woven fabric, and thereby desired print images can be obtained. Thus, it becomes possible to obtain reversibly thermochromic ink-printed materials.

### [Ink Cartridge]

The ink composition may be contained in an ink cartridge.

There are no particular restrictions on the ink cartridge as long as it can contain the ink composition, and hence the cartridge can be freely selected from various shapes and materials.

Examples of materials for the ink cartridge include: plastics, such as, polyethylene terephthalate (PET), ABS resin, and polystyrene (PS); various metals (including alloys); and polyolefin, such as, polyethylene, ethylene-vinyl acetate copolymer, and polypropylene. Further, the materials are not limited to them. For example, they may be polymers obtained by mixing proper ratios of the above polymers or films and the like thereof. Examples of the shapes of the ink cartridge include: packs, bottles, tanks, and cans.

In the ink cartridge, there may be two or more independent ink-storing chambers in which two or more ink compositions having different colors are individually contained.

Further, a plural number of the ink cartridges may be combined to assemble an ink cartridge set. The ink cartridge set may consist of cartridges containing either the same color ink or a plural number of different color Inks.

Furthermore, the ink cartridge may have a structure in which the ink composition is supplied to the ink flow channel when installed in the inkjet printer.

### EXAMPLES

Examples will be described below. In the examples, the term “part(s)” means weight part(s).

### Example 1

### (Preparation of Reversibly Thermochromic Microcapsule Pigment)

A reversibly thermochromic composition was prepared by mixing: 3.0 parts of 7-[2-(acetylamino)-4-(diethylamino)phenyl]-7-(2-methyl-1-propyl-1H-indole-3-yl)flo[3,4-b] pyridine-5(7H)-one, as the component (A); 15.0 parts of 1,1′-bis(4′-hydroxyphenyl) n-nonane, as the component (B); and 50.0 parts of 4-benzyloxyphenylethyl caprate, as the component (C). The obtained composition was added into a mixture of: 45 parts of aromatic multivalent isocyanate prepolymer as the membrane material; and 40.0 parts of co-solvent. The resultant mixture was emulsified and dispersed in a 10% aqueous solution of polyvinyl alcohol, and then stirred with heating at a stirring speed of 10000 rpm by means of a homomixer. Subsequently, 2.5 parts of water-soluble modified aliphatic amine was added therein and the mixture was further kept stirred to prepare a microcapsule pigment dispersion. The microcapsule pigment dispersion was then filtrated through a filter-press machine, to obtain a microcapsule pigment.

The volume-based mean particle size (X) of microcapsules contained in the reversibly thermochromic microcapsule pigment was measured by use of a laser diffraction/scattering-type particle size distribution analyzer (LA-300 (product name, manufactured by HORIBA, Ltd.) with calibration according to image analysis. As a result, the volume-based mean particle size (X) and the maximum particle diameter were found to be 0.75 μm and 1.8 μm, respectively.

The mean cross-sectional membrane thickness (Y) of microcapsules contained in the reversibly thermochromic microcapsule pigment was measured by the steps of: freezing an aqueous dispersion of the pigment when the reversibly thermochromic composition was colored, so as to avoid fluctuation caused by deformation of the pigment; preparing a thin section sample of 50 μm thickness from the frozen dispersion with a microtome; and observing and analyzing the thin section sample with a transmission electron microscope (HT7700, product name, manufactured by Hitachi High-Tech Corporation). There were 150 microcapsules in the observation field. From the image analysis, the cross-sectional membrane thicknesses of all the microcapsules were calculated and averaged. Thus, the mean cross-sectional membrane thickness (Y) was found to be 0.08 μm.

The obtained microcapsule pigment was found to have a complete decoloring temperature t₄ and a complete coloring temperature t₁ at 60° C. and −25° C., respectively, and also found to change the color from cyan to colorless when heated.

### (Preparation of Reversibly Thermochromic Aqueous Ink Composition)

A reversibly thermochromic aqueous ink composition was obtained by mixing: 10 parts of the obtained microcapsule pigment (which was beforehand cooled to develop the color), 10 parts of glycerin, 1.2 parts of a polyether phosphate ester (PHOSPHANOL RS-410 product name, manufactured by TOHO Chemical Industry Co., Ltd.), 0.2 part of a preservative (pyridine-2-thiol 1-oxide, sodium salt, Sodium Omadine [trademark], manufactured by Lonza Japan Ltd.), 0.2 part of another preservative (3-iodo-2-propynyl butylcarbamate, Glycacil 2000 product name, manufactured by Lonza Japan Ltd.), 0.02 part of an antifoaming agent, 0.1 part of a pH adjuster (citric acid), and 78.28 parts of water.

The viscosity of the obtained aqueous ink composition was measured and found to be 5.46 mPa-s at a temperature of 20° C. and a rotation rate of 30 rpm. The obtained aqueous ink composition was stored in an ink cartridge made of polystyrene.

### Example 2

### (Preparation of Reversibly Thermochromic Microcapsule Pigment)

The reversibly thermochromic microcapsule pigment obtained in Example 1 was employed.

### (Preparation of Reversibly Thermochromic Aqueous Ink Composition)

A reversibly thermochromic aqueous ink composition was obtained by mixing: 10 parts of the obtained microcapsule pigment (which was beforehand cooled to develop the color), 6.5 parts of glycerin, 2.5 parts of 1,2-ethanediol, 1 part of 1,3-butanediol, 1.2 parts of a polyether phosphate ester (PHOSPHANOL RS-710, product name, manufactured by TOHO Chemical Industry Co., Ltd.), 0.2 part of a preservative (pyridine-2-thiol 1-oxide, sodium salt, Sodium Omadine, product name, manufactured by Lonza Japan Ltd.), 0.2 part of another preservative (3-iodo-2-propynyl butylcarbamate, Glycacil 2000, product name, manufactured by Lonza Japan Ltd.), 0.02 part of an antifoaming agent, 0.1 part of a pH adjuster (citric acid), and 78.28 parts of water.

The viscosity of the obtained aqueous ink composition was measured and found to be 4.96 mPa-s at a temperature of 20° C. and a rotation rate of 30 rpm. The obtained aqueous ink composition was stored in an ink cartridge made of polystyrene.

### Examples 3 to 20

The added amount of the membrane material and the condition of stirring speed in Example 1 were changed into those shown in Table 1, to prepare reversibly thermochromic microcapsule pigments and reversibly thermochromic aqueous ink compositions of Examples 3 to 20.

### Example 21

The procedure of Example 16 was repeated except for changing the aqueous solution of polyvinyl alcohol in Example 16 into an 8% aqueous solution of polyvinyl alcohol, to obtain a reversibly thermochromic microcapsule pigment and a reversibly thermochromic aqueous ink composition. The obtained aqueous ink composition was stored in an ink cartridge made of polystyrene.

### Comparative Example 1

The added amount of the membrane material and the condition of stirring speed in Example 2 were changed into those shown in Table 1, to prepare a reversibly thermochromic microcapsule pigment. The obtained aqueous ink composition was stored in an ink cartridge made of polystyrene.

### Comparative Example 2

The added amount of the membrane material and the condition of stirring speed in Example 1 were changed into those shown in Table 1, to prepare a reversibly thermochromic microcapsule pigment. The obtained aqueous ink composition was stored in an ink cartridge made of polystyrene.

Table 1 shows the mean particle sizes (Xs), the mean cross-sectional membrane thicknesses (Ys), the Y/X ratios, and the maximum particle diameters of microcapsules contained in the reversibly thermochromic microcapsule pigments obtained in Examples 1 to 21 and Comparative examples 1 and 2.

The maximum particle diameter of microcapsules contained in the microcapsule pigment obtained in Example 21 was 5 μm or more, and the content ratio of microcapsules having diameters of 5 μm or more (large particle ratio) thereof was 1.2 volume % based on the total volume of the microcapsule pigment. However, the large particle ratios in all of the other examples were found to be 0 volume %.

Each obtained ink cartridge was installed in an inkjet printer, and each ink composition and printing performance thereof were evaluated according to the following procedures. The printing conditions were set as follows: the amount of ejected ink was 10 μL per pixel, and the printing resolution was vertical 600 dpi×horizontal 600 dpi.

(Color Development of Printing) A straight line of 0.2 mm width was printed with an inkjet printer fitted with the cartridge, and color development of the printed line was visually observed. The printing paper was inkjet plain paper available from Seiko Epson Corporation.

The evaluation grades are as follows:

A: the printed color was very thick and clear,
B: the printed color was thick,
C: the printed color was slightly thin but enough recognizable,
D: the printed color was somewhat thin but practically acceptable, and
E: the printed color was too thin to recognize and practically problematic.

### (Resolution of Printing)

The letters “KOMORONARU” were printed and visually observed. The printing paper was the same as that used in the evaluation of color development.

The evaluation grades are as follows:

A: the letters were not blurred and the outlines of the letters were clear,
B: the letters were slightly blurred, or the outlines of the letters were slightly unclear but practically acceptable, and
C: the letters were seriously blurred, or the outlines of the letters were unclear and practically problematic.

### (Temporal Stability of Ink)

The ink cartridge used in the above evaluation of printing color development was stored at 40° C. for 30 days. Thereafter, the ink cartridge was installed in an inkjet printer, and a straight line of 0.2 mm width was printed. The printed line was visually compared to the line beforehand printed with the cartridge before stored with respect to the color development.

The evaluation grades are as follows:

A: the color density was not changed,
B: the color density of the line printed with the stored cartridge was slightly thinner,
C: the color density of the line printed with the stored cartridge was somewhat thinner but practically acceptable, and
D: the color density of the line printed with the stored cartridge was much thinner and practically problematic.

The results were shown in Table 1.

### Application Examples

The procedure of Example 1 was repeated except for changing the components of the reversibly thermochromic color-memory composition into those described below, to prepare reversibly thermochromic microcapsule pigments and reversibly thermochromic aqueous ink compositions. Thus, the ink compositions of Application examples A to C were obtained.

### Application Example A

### (Magenta Color)

A reversibly thermochromic composition containing: as the component (A), 6.0 parts of 9-ethyl-(3-methylbutyl)amino-spiro[12H-benzo[a] xanthene-12,1′(3H)-isobenzofuran]-3′-one; as the component (B), 15.0 parts of 4,4′-(2-ethylhexylidene)bisphenol; and, as the component (C), 50.0 parts of 4-benzyloxyphenylethyl caprate.

### Application Example B

### (Yellow Color)

A reversibly thermochromic composition containing: as the component (A), 3.0 parts of 4-[2,6-bis (2-ethoxyphenyl)-4-pyridinyl]-N,N-dimethylbenzeneamine; as the component (B), 9.0 parts of 2,2-bis(4-hydroxyphenyl)hexafluoropropane; and, as the component (C), 50.0 parts of 4-benzyloxyphenylethyl caprate.

### Application Example C

### (Black Color)

A reversibly thermochromic composition containing: as the component (A), 7.0 parts of 2-(2-chloroanilino)-6-di-n-butylaminofluoran; as the component (B), 15.0 parts of 1,1′-bis(4′-hydroxyphenyl) n-dodecane; and, as the component (C), 50.0 parts of 4-benzyloxyphenylethyl caprate.

### (Production of Multicolor Ink Cartridge)

The inks prepared in Example 1 and Application examples A to C were loaded in a single ink cartridge, to produce a multicolor ink cartridge capable of ejecting four color inks of magenta, cyan, yellow and black.

### [Table 1]

TABLE 1

| | | | mean cross- | | | | | | | |
|---|---|---|---|---|---|---|---|---|---|---|
| | | mean | sectional | | amount of | | large | | | |
| | | particle | membrane | | membrane | stirring | particle | | | temporal |
| | | size | thickness | | material | speed | ratio | color | | stability |
| | | (X) (μm) | (Y) (μm) | Y/X | (g) | (rpm) | (vol %) | development | resolution | of ink |
| Ex. | 1 | 0.75 | 0.08 | 0.11 | 45 | 10000 | 0 | A | A | A |
| | 2 | 0.75 | 0.08 | 0.11 | 45 | 10000 | 0 | A | A | A |
| | 3 | 1 | 0.14 | 0.14 | 55 | 8500 | 0 | A | A | A |
| | 4 | 0.35 | 0.05 | 0.14 | 55 | 14000 | 0 | A | A | A |
| | 5 | 0.7 | 0.02 | 0.03 | 25 | 12000 | 0 | A | A | C |
| | 6 | 0.8 | 0.11 | 0.14 | 50 | 10000 | 0 | A | A | A |
| | 7 | 0.85 | 0.06 | 0.07 | 35 | 9500 | 0 | A | A | A |
| | 8 | 0.9 | 0.17 | 0.19 | 65 | 9000 | 0 | A | A | A |
| | 9 | 1.45 | 0.34 | 0.23 | 75 | 6500 | 0 | B | A | A |
| | 10 | 1.6 | 0.31 | 0.19 | 65 | 5500 | 0 | A | B | A |
| | 11 | 1.2 | 0.26 | 0.22 | 70 | 7500 | 0 | B | A | A |
| | 12 | 1.1 | 0.29 | 0.26 | 85 | 7500 | 0 | C | A | A |
| | 13 | 0.5 | 0.14 | 0.28 | 85 | 12000 | 0 | C | A | A |
| | 14 | 1.2 | 0.37 | 0.31 | 95 | 7500 | 0 | D | A | A |
| | 15 | 1.9 | 0.32 | 0.17 | 60 | 5000 | 0 | A | B | A |
| | 16 | 1.2 | 0.045 | 0.04 | 30 | 7500 | 0 | A | A | B |
| | 17 | 1.4 | 0.08 | 0.06 | 30 | 7000 | 0 | A | A | A |
| | 18 | 1.6 | 0.1 | 0.06 | 35 | 5400 | 0 | A | B | A |
| | 19 | 1.8 | 0.05 | 0.03 | 25 | 5200 | 0 | A | B | C |
| | 20 | 1.8 | 0.2 | 0.11 | 45 | 5300 | 0 | A | B | A |
| | 21 | 1.4 | 0.08 | 0.06 | 30 | 7000 | 1.2 | A | B | A |
| Com. | 1 | 0.75 | 0.01 | 0.01 | 15 | 10000 | 0 | A | A | D |
| | 2 | 2.2 | 0.35 | 0.16 | 55 | 4500 | 0 | A | C | A |

### EXPLANATION OF REFERENCES

t₁: complete coloring temperature,
t₂: coloring starting temperature,
t₃: decoloring starting temperature,
t₄: complete decoloring temperature,
T₁: complete decoloring temperature,
T₂: decoloring starting temperature,
T₃: coloring starting temperature,
T₄: complete coloring temperature,
1: ink-supplying unit,
2: ink container,
3: printer head,
3a: ink-outlet,
3b: ink-inlet,
3c: inner channel,
4a: ink-supplying channel,
4b: ink-recovering channel,
5: pump,
6: wiping means,
7: nozzle,
8: ink-discharging port,
9: ink composition.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and sprit of the invention.

1. A reversibly thermochromic aqueous inkjet printer ink composition, comprising:
a reversibly thermochromic microcapsule pigment containing microcapsules in which
a reversibly thermochromic composition containing:
(A) an electron-donative coloring organic compound,
(B) an electron-accepting compound, and
(C) a reaction medium for reversibly causing an electron transfer reaction between the components (A) and (B) in a specific temperature range
is enclosed with a membrane,
water, and
a polyalcohol organic solvent;
wherein
said microcapsules have a volume-based mean particle size (X) of 0.1 to 2 μm and a mean cross-sectional membrane thickness (Y) of 0.02 to 0.4 μm, provided that said mean cross-sectional membrane thickness is defined by the steps of
observing cross-sections of said microcapsules in the frozen state with a transmission electron microscope,
calculating cross-sectional membrane thicknesses of all the microcapsules in the observation field according to the following formula:
cross-sectional membrane thickness=(outer section diameter−inner section diameter)/2
(in which the outer and inner section diameters of each microcapsule are circle conversion diameters calculated from areas surrounded by the outer and inner circumferences, respectively), and
averaging the calculated thicknesses to determine the mean cross-sectional membrane thickness.

2. The ink composition according to claim 1, wherein
said mean particle size (X) and said mean cross-sectional membrane thickness (Y) satisfy the condition represented by the following formula (1):
Y/X<0.3 (1).

3. The ink composition according to claim 1, wherein
said mean particle size (X) and said mean cross-sectional membrane thickness (Y) satisfy the condition represented by the following formula (2):
0.02<Y/X (2).

4. The ink composition according to claim 1, wherein said mean particle size (X) is in the range of 0.3 to 1.5 μm.

5. The ink composition according to claim 1, wherein said microcapsules have said mean cross-sectional membrane thickness (Y) of 0.02 to 0.3 μm.

6. The ink composition according to claim 1, wherein microcapsules having diameters of 5 μm or more are contained in an amount of 1 volume % or less based on the total volume of the microcapsules in said microcapsule pigment.

7. The ink composition according to claim 1, wherein the blending ratio of said microcapsule pigment is in the range of 3 to 20 mass % based on the total mass of said aqueous ink composition.

8. The ink composition according to claim 1, wherein said polyalcohol organic solvent is glycerin or an alkanediol.

9. The ink composition according to claim 1, wherein the content ratio of the polyalcohol organic solvent is 5 to 60 mass %.

10. The ink composition according to claim 1, which further contains a polyether phosphate ester.

11. The ink composition according to claim 10, wherein said polyether phosphate is an alkali metal salt, an ammonium salt or an alkanolamine salt.

12. The ink composition according to claim 10, the content ratio of said polyether phosphate ester is 1 to 10 mass %.

13. The ink composition according to claim 1, wherein said ink composition has a viscosity of 2 to 30 mPa-s at 20° C.

14. The ink composition according to claim 1, wherein said ink composition has a surface tension of 20 to 50 mN/m at 20° C.

15. The ink composition according to claim 1, said ink composition has a pH value of 4 to 8 at 20° C.

16. An inkjet printer loaded with the ink composition according to claim 1.

17. An ink cartridge charged with the ink composition according to claim 1.
